(19) United States
(12) Patent Application Publication
(10) Pub. No.: US 2011/0197279 A1
(43) Pub. Date: Aug. 11, 2011

(54) MANAGEMENT METHODS OF STORAGE SYSTEM AND FILE SYSTEM

(75) Inventor: Atsushi Ueoka, Machida (JP)

(73) Assignee: Hitachi, Ltd.

(21) Appl. No.: 12/527,661

(22) PCT Filed: May 29, 2009
(86) PCT No.: PCT/JP2009/002395

§ 371 Date: Aug. 18, 2009

(51) Int. Cl. G06F 12/14; G06F 21/00

(52) U.S. Cl. 726/24

(57) ABSTRACT

If a file infected with an unknown virus is stored in the file system provided by the NAS system, this invention prevents the invasion of the virus when recovering from the backup data. If the anti-virus program 16 running in the management server 1 detects the infected file in the file system provided by the NAS system 3, the secondary volume selection program 18 running in the management server 1 selects the replicated volumes 51a, 51b, and 51c newer than the creation dates and time of the infected files, and the anti-virus program 16 performs virus scanning for the infected files of the selected secondary volumes 51a, 51b, and 51c and removes the virus.

### TECHNICAL FIELD

This invention relates to the management methods of storage systems and file systems, for example, to the virus scanning method for the backup data to be used for recovering the NAS system and the virus scanning method for recovering the NAS system.

### BACKGROUND ART

The NAS (Network Attached Storage) system is connected with the network and provides for the file systems available to multiple computers via the network. The file systems provided by the NAS system are shared by multiple computers. Therefore, if an infected file is stored in the file system provided by the NAS system (a volume storing multiple files), the virus might spread across all the computers using the file system, which might cause significant damages. Therefore, by scanning the file systems provided by the NAS system for viruses, such damages can be prevented. Furthermore, in case a failure occurs to the file systems, the backups and snapshots of the file systems are obtained. The backups include replication i.e. copying a file system to another file system and creating backups in external storage devices such as tapes.

If an infected file is included in the backup data of an external storage device, the virus invades the file system at the time of recovery. As the measures against such a situation, for example, the Patent Document 1 discloses performing virus scanning when creating backups.

Furthermore, the Patent Document 2 discloses the methods of scheduling the processing related to the NAS system operations such as backups and virus scans. By these methods, after performing virus scanning, the backups can be obtained. Furthermore, after recovering data from the backups, by creating the schedule of performing virus scanning, the virus can be removed after the recovery, before the file system is available to the computers.

### Citation List

### Patent Literature

PTL 1: Japanese Patent Application Laid-Open Publication No. 2007-219611
PTL 2: Japanese Patent Application Laid-Open Publication No. 2006-268594

### SUMMARY OF INVENTION

### Technical Problem

However, the programs of performing virus scanning disclosed in the Patent Document 1 can only detect and remove the viruses which are known and registered to the virus definition files. Therefore, by the above-mentioned methods, the files infected with an unknown virus not registered to the virus definition files are backed up with the virus unremoved, and at the time of recovery (when restoring the file from which the virus is considered to have been removed), the virus invades the file.

Furthermore, by the method disclosed by the Patent Document 2, for performing virus scanning after recovering the file system, all the files in the file system are scanned for viruses and such virus scanning takes a long time, which takes a long time before the file system is available again.

Furthermore, as for the system using the read-only snapshots, the virus cannot be removed by virus scanning, and the virus might spread across all the computers using the snapshots. It is also possible that the infected file is copied from the snapshots to the file system.

This invention is intended in view of such a situation, and provides for the technology of ensuring the prevention of starting the operation with any viruses still invading the file system.

### Solution to Problem

For solving the above-mentioned problems, this invention identifies the backup data created after the creation date and time of the file in whose primary volume a virus has been detected, and performs the specific processing for the relevant identified backup data. For example, if the backup data is the data stored in the secondary volume or in the external storage device, the virus scanning is performed only for the data in the identified secondary volume or external storage device. Meanwhile, if the backup data is the snapshot, the attribute of the file in the primary volume corresponding with the identified snapshot is changed to inaccessible.

That is, the storage system by this invention includes a storage device, a file system providing unit (NAS system), a virus detection and removal unit, a backup creation date and time storing unit, and a backup data identifying unit. The storage device includes primary volumes and the backup data storage for storing the backup data of the primary volumes. The file system providing unit is connected with the storage device, and provides the primary volumes as the file systems to the client. The virus detection and removal unit performs virus scanning for the files stored in the file system, and detects and removes the viruses. Furthermore, the backup creation date and time storing unit is the table for managing the date and time of creating backup data with reference to the primary volumes. The backup data identifying unit, with reference to the information from the backup creation date and time storing unit, identifies the backup data whose creation date and time is newer than that of the file in which the virus has been detected. Then, the virus detection and removal unit performs virus scanning for the identified backup data. In addition to the cases where the viruses are detected, in the cases where files are updated in or deleted from the primary volumes, virus scanning can be performed for the backup data with the newer creation date and time than this update/deletion date and time.

If the backup data is the secondary volume created by replicating the primary volume, after the above-mentioned virus scanning, the unmount command unit issues a command to the file system providing unit for suspending providing the file system corresponding with the secondary volume identified by the backup data identifying unit. Then, the file system providing unit, according to the command from the unmount command unit, suspends providing the file system corresponding with the identified secondary volume.

If the backup data is the snapshot for enabling the access to the primary volume, instead of virus scanning by the virus detection and removal unit, the attribute of the files in the primary volume corresponding with the snapshot identified by the backup data identifying unit is changed inaccessible. Note that, for using the snapshot, the storage device further includes the differential volume for storing the pre-update data of the relevant updated part of the data if the data stored in the primary volume is updated. Furthermore, the snapshot is created with reference to the part of the data which is not updated in the primary volume and the pre-update data stored in the differential volume.

Furthermore, if the backup data is the data stored in the external storage device, before restoring the backup data from the external storage device to the file system, the virus detection and removal unit performs virus scanning for the identified backup data. In addition to the cases where the viruses are detected, in the cases where files are updated in or deleted from the primary volumes, virus scanning can be performed for the backup data with the newer creation date and time than this update/deletion date and time.

Further characteristics of this invention are described by the following Best Modes for Carrying Out the Invention and the attached figures.

### Advantageous Effects of Invention

This invention ensures the prevention of starting the operation with any viruses still invading the file system.

### BRIEF DESCRIPTION OF DRAWINGS

FIG. 1 is a diagram showing the configuration overview of the storage system by the first and the second embodiments of this invention.

FIG. 2 is a diagram showing the configuration overview of the management server by the first embodiment.

FIG. 3 is a diagram showing the configuration overview of the NAS client.

FIG. 4 is a diagram showing the configuration overview of the NAS system by the first and the fourth embodiments.

FIG. 5 is a diagram showing the configuration overview of the storage device by the first embodiment.

FIG. 6 is a diagram showing an example form of the virus scanning history file.

FIG. 7 is a diagram showing an example form of the file system management table.

FIG. 8 is a diagram showing an example form of the access log file.

FIG. 9 is a diagram showing an example form of the replication history file.

FIG. 10 is a flowchart showing the processing of the secondary volume selection program by the first embodiment.

FIG. 11 is a flowchart showing the processing of the server communication program.

FIG. 12 is a flowchart showing the processing of the client communication program by the first embodiment.

FIG. 13 is a diagram showing the configuration overview of the management server by the second embodiment.

FIG. 14 is a diagram showing the configuration overview of the NAS system by the second embodiment.

FIG. 15 is a diagram showing the configuration overview of the storage device by the second, third and fifth embodiments.

FIG. 16 is a diagram showing the relationship between primary volumes, differential volumes, and snapshots.

FIG. 17 is a diagram showing an example form of the snapshot history table.

FIG. 18 is a diagram showing an example form of the virus infection file list table.

FIG. 19 is a flowchart showing the processing of the snapshot control program.

FIG. 20 is a flowchart showing the processing of the client communication program by the second embodiment.

FIG. 21 is a diagram showing the configuration overview of the storage system by the third embodiment of this invention.

FIG. 22 is a diagram showing the configuration overview of the management server by the third embodiment.

FIG. 23 is a diagram showing the configuration overview of the NAS system by the third embodiment.

FIG. 24 is a diagram showing an example form of the backup history file.

FIG. 25 is a flowchart showing the processing of the file selection program.

FIG. 26 is a diagram showing the configuration overview of the storage system by the fourth embodiment of this invention.

FIG. 27 is a diagram showing the configuration overview of the management server by the fourth embodiment.

FIG. 28 is a diagram showing the configuration overview of the storage device by the fourth embodiment.

FIG. 29 is a diagram showing an example form of the remote copy history file by the fourth embodiment.

FIG. 30 is a flowchart showing the processing of the remote communication program by the fourth embodiment.

FIG. 31 is a diagram showing the configuration overview of the storage system by the fifth embodiment of this invention.

FIG. 32 is a diagram showing the configuration overview of the management server by the fifth embodiment.

FIG. 33 is a diagram showing the configuration overview of the NAS system by the fifth embodiment.

FIG. 34 is a diagram showing an example form of the remote copy history file by the fifth embodiment.

FIG. 35 is a flowchart showing the processing of the remote communication program by the fifth embodiment.

### DESCRIPTION OF EMBODIMENTS

The embodiments of this invention are described below by referring to the attached figures. However, it should be noted that these embodiments are intended for achieving this invention and not limited to the particular constructions. Note that a common numeral is added to each of the common configurations.

### (1) First Embodiment

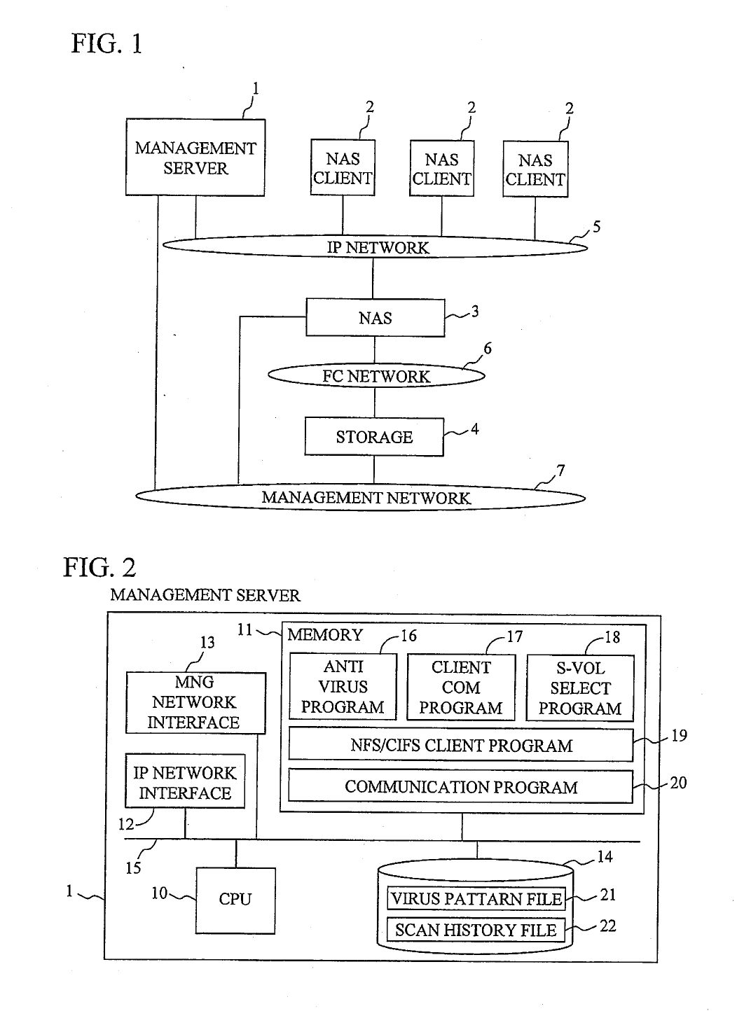

The first embodiment relates to the system using a physically separate volume (hereinafter referred to as a secondary volume (S-VOL)) in which the data of the volume corresponding with the file system as the backup of the NAS system (hereinafter referred to as a primary volume (P-VOL)) is replicated and stored. The first embodiment is described below by referring to FIGS. 1 to 12.

System Configuration

FIG. 1 is a diagram showing the configuration overview of the storage system by the first embodiment of this invention. As shown in FIG. 1, the relevant system includes a management server 1, at least one NAS system 3, at least one storage device 4, at least one NAS client 2 performing file access to the NAS system 3, an IP (Internet Protocol) network 5 connecting the management server 1, the NAS system 3 and the NAS client 2, a management network 7 for connecting the management server 1, the NAS system 3 and the storage device 4, and an FC (Fibre Channel) network 6 for connecting the NAS system 3 and the storage device 4. Note that this embodiment includes three networks i.e. the IP network 5, the FC network 6, and the management network 7 for convenience, but the types of networks are not limited to them. One network may also be permitted.

Management Server Configuration

FIG. 2 is a diagram showing the configuration overview of the management server by this embodiment. As shown in the figure, the management server 1 includes a CPU 10, a memory 11, an IP network interface 12 for the connection with the IP network 5, a management network 7 interface 13 for the connection with the management network, a hard disk 14 and the internal bus 15 for connecting these components.

The memory 11 includes an anti-virus program 16 performing virus scanning for the file system provided by the NAS system 3 to the management server 1, a client communication program 17 communicating with the NAS client 2, a secondary volume selection program 18 for selecting the secondary volume corresponding with the primary volume of the file system in which the infected file is stored, an NFS/CIFS client program 19 for accessing the file system provided by the NAS system 3, and a communication program 20 for the communication by the communication protocols of the IP network 5 and the management network 7. These programs operate as relevant processing units in collaboration with the CPU 10. For example, the anti-virus program 16 operates as the anti-virus processing unit 16 in collaboration with the CPU 10.

The hard disk 14 stores a virus pattern file 21 used by the anti-virus program 16 when detecting viruses and a virus scanning history file 22 for storing the virus detection and removal history by the anti-virus program 16.

Note that, though not shown in the figure, the memory 11 stores an operating system.

NAS Client Configuration

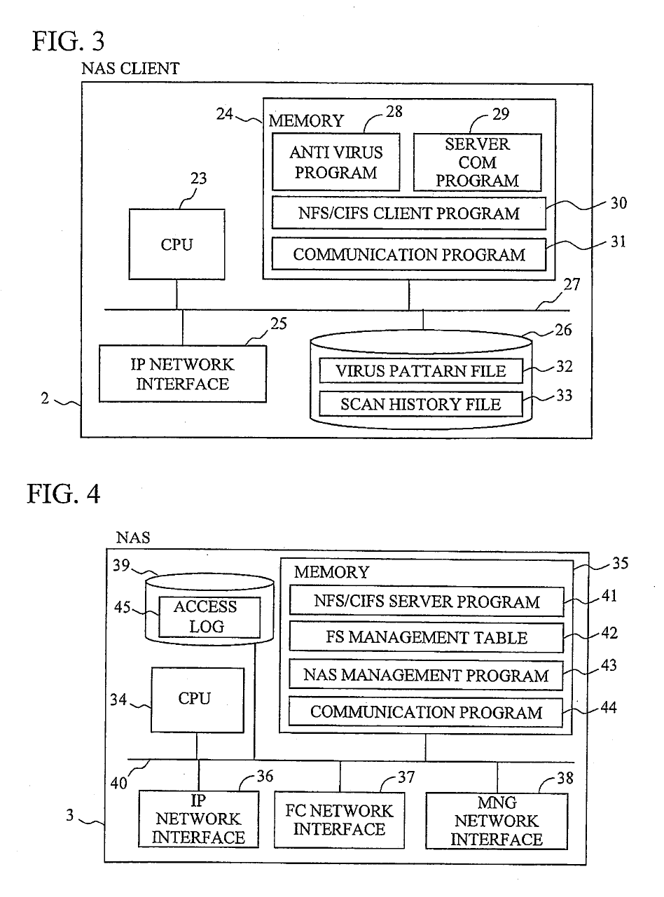

FIG. 3 is a diagram showing an example of the configuration overview of the NAS client 2 by this embodiment. As shown in the figure, the NAS client 2 includes a CPU 23, a memory 24, an IP network interface 25 for the connection with the IP network 5, a hard disk 26, and an internal bus 27.

The memory 24 stores an anti-virus program 28 performing virus scanning for the file system provided by the NAS system 3, a server communication program 29 communicating with the management server 1, an NFS/CIFS client program 30 for accessing the file system provided by the NAS system 3, and a communication program 31 for the communication by the communication protocols of the IP network 5. As the above-mentioned programs, these programs operate as relevant processing units in collaboration with the CPU 23. For example, the anti-virus program 16 operates as the anti-virus processing unit 28 in collaboration with the CPU 23.

The hard disk 26 stores a virus pattern file 32 used by the anti-virus program 28 when detecting viruses and a virus scanning history file 33 for storing the virus detection and removal history by the anti-virus program 28.

Note that, though not shown in the figure, the memory 24 stores an operating system.

NAS System Configuration

FIG. 4 is a diagram showing an example of the configuration overview of the NAS system 3 by this embodiment. As shown in the figure, the NAS system 3 includes a CPU 34, a memory 35, an IP network interface 36 for the connection with the IP network 5, an FC network interface 37 for the connection with the FC network 6, a management network interface 38 for the connection with the management network 7, a hard disk 39, and an internal bus 40 for connecting these components.

The memory 35 stores an NFS/CIFS server program 41 controlling the accesses from the management server 1 and the NAS client 2 to the file system provided by the NAS system 3, an NAS management program 43 for controlling the NAS system 3, and a communication program 44 for the communication by the communication protocols of the IP network 5, the FC network 6 and the management network 7. As the above-mentioned programs, these programs operate as relevant processing units in collaboration with the CPU 34. For example, the NAS management program 43 operates as the NAS management unit 43 in collaboration with the CPU 34.

The memory 35 also stores a file system management table 42 storing the correspondence of the file systems provided by the NAS system 3 with the volumes provided by the storage device 4.

The hard disk 39 stores an access log file 45 recording the access history from the NAS client 2 to the file system provided by the NAS system 3 to the NAS client 2. Note that the NFS/CIFS server program 41 performs the recording of the access history to the access log file 45.

Storage Device Configuration

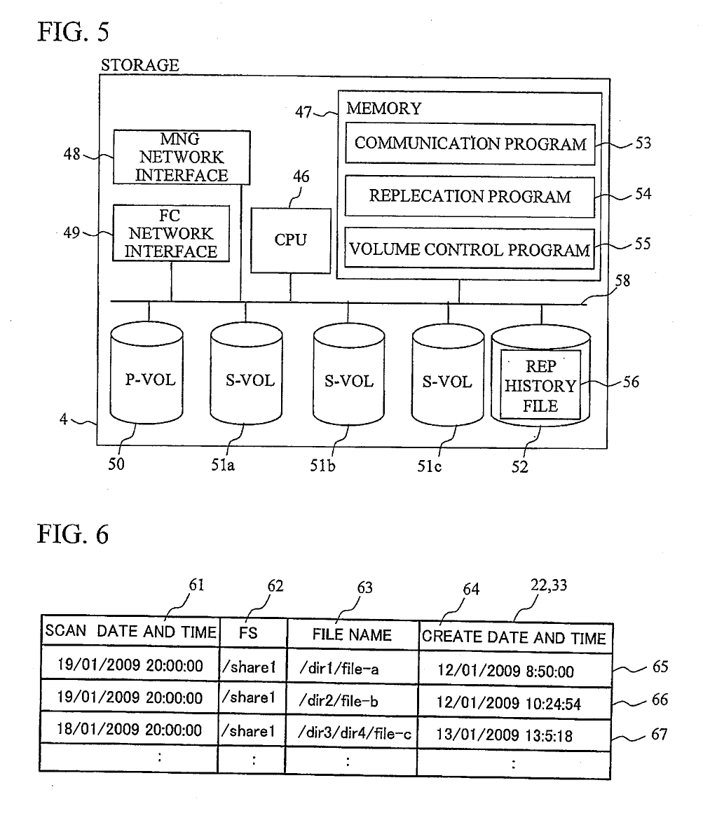

FIG. 5 is a diagram showing an example of the configuration overview of the storage device 4 by this embodiment. As shown in the figure, the storage device 4 includes a CPU 46, a memory 47, an FC network interface 49 for the connection with the FC network 49, a management network interface 48 for the connection with the management network 7, a primary volume 50, a secondary volume 51a, a secondary volume 51b, a secondary volume 51c, a hard disk 52, and an internal bus 58 for connecting these components.

The primary volume 50 is the volume mounted and used by the NAS system 3. The NAS system 3 provides the mounted primary volume 50 as a file system to the management server 1 and the NAS client 2. The secondary volumes 51a, 51b, and 51c are the volumes for saving the data replicated from the data stored in the primary volume at certain points of time, and each of these volumes store the data replicated from the data stored in the primary volume at a different point of time.

The memory 47 stores a communication program 53 for the communication by the communication protocols of the FC network 6 and the management network 7, a replication program 54 for replicating the primary volume 50 to the secondary volumes 51 a, 51b, and 51c, and a volume control program 55 for controlling the access to the primary volume 50 and the secondary volumes 51a, 51b, and 51c. As the above-mentioned programs, these programs operate as relevant processing units in collaboration with the CPU 46. For example, the replication program 54 operates as the replication processing unit 54 in collaboration with the CPU 46.

The hard disk 52 stores a replication history file 56 recording the history of replicating the primary volume 50 to the secondary volumes 51a, 51b, and 51c by the replication program 54.

Example of Virus Scanning History Files

FIG. 6 is a diagram showing an example form of the virus scanning history files 22 and 33. Note that the virus scanning history files 22 and 33 are not necessarily the files of the same contents. They are different from each other if their targets of virus scanning are different.

As shown in the figure, each of the virus scanning history files 22 and 33 includes the field 61 recording the date and time of starting virus scanning, the field 62 recording the file system name for which the virus scanning is executed on the date and time of the field 61, the field 63 recording the file system name of the field 62 where the virus is detected and removed, and the field 64 recording the creation date and time of the file of the field 63. By this information, the infected file, the file system in which the file has been stored, and the date and time of starting the virus scanning are ascertained.

For example, the entry of the numeral 65 in FIG. 6 shows that the file “/dir1/file-a” created at 08:50:00 on Jan. 12, 2009, stored in the file system “share 1” had a virus detected and removed by the virus scanning started at 20:00:00 on Jan. 19, 2009.

Example of file System Management Table

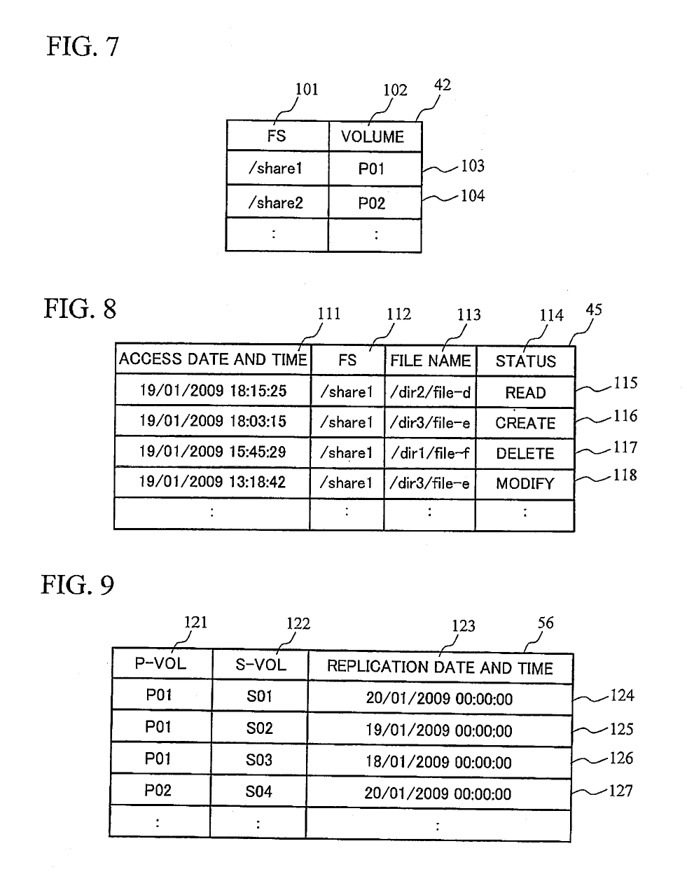

FIG. 7 is a diagram showing an example form of the file system management table 42. As shown in the figure, the file system management table 42 includes the field 101 recording the file system name and the field 102 recording the volume name. By this information, the volume provided by the storage device 4 corresponding with the file system provided by the NAS system 3 can be ascertained.

For example, the entry of the numeral 103 shows that the volume “P01” is provided as the file system “/share1.”

Example of Access Log File

FIG. 8 is a diagram showing an example form of the access log file 45. As shown in the figure, the access log file 45 includes the field 111 recording the access date and time, the field 112 recording the accessed file system name, the field 113 recording the accessed file name, and the field 114 recording the access type such as read, create, update, delete etc. By this information, the accessed files, the file systems where those files are stored, the access date and time, and the access types can be ascertained.

For example, the entry of the numeral 115 shows that the file “/dir2/file-d” stored in the file system “/share1” received a read access at 18:15:25 on Jan. 19, 2009. Furthermore, the entries of the numerals 116 and 118 show that the file “/dir3/file-e” of the file system “/share1” was created at 13:18:42 on Jan. 19, 2009 and updated at 18:03:15 on Jan. 19, 2009. Furthermore, the entry of the numeral 118 shows that the file “/dir1/file-f′ stored in the file system “/share1” was deleted at 15:45:29 on Jan. 19, 2009.

Example of Replication History File

FIG. 9 is a diagram showing an example form of the replication history file 56. As shown in the figure, the replication history file 56 includes the field 121 recording the name of the source primary volume 50, the field 122 recording the secondary volumes 51a, 51b, and 51c which are the replication of the primary volume 50 of the field 121, the field 123 recording the date and time of replicating the primary volume 50 of the field 121 to the secondary volumes 51a, 51b, and 51c of the field 122. By this information, the secondary volumes 51a, 51b, and 51c which are the replication of the primary volume 50 and the replication date and time are ascertained.

For example, the entry of the numeral 124 shows that the primary volume “P01” was replicated to the secondary volume “S01” at 00:00:00 on Jan. 20, 2009. Furthermore, the entries of the numerals 125 and 126 show that the primary volume “P01” was replicated to the secondary volume “S02” at 00:00:00 on Jan. 19, 2009, and was replicated to the secondary volume “S03” at 00:00:00 on Jan. 18, 2009. That is, it can be ascertained that the primary volume “P01” was replicated to the three secondary volumes “S01,” “S02,” and “S03” at different points of time (dates and time).

Processing Details of Secondary Volume Selection Program

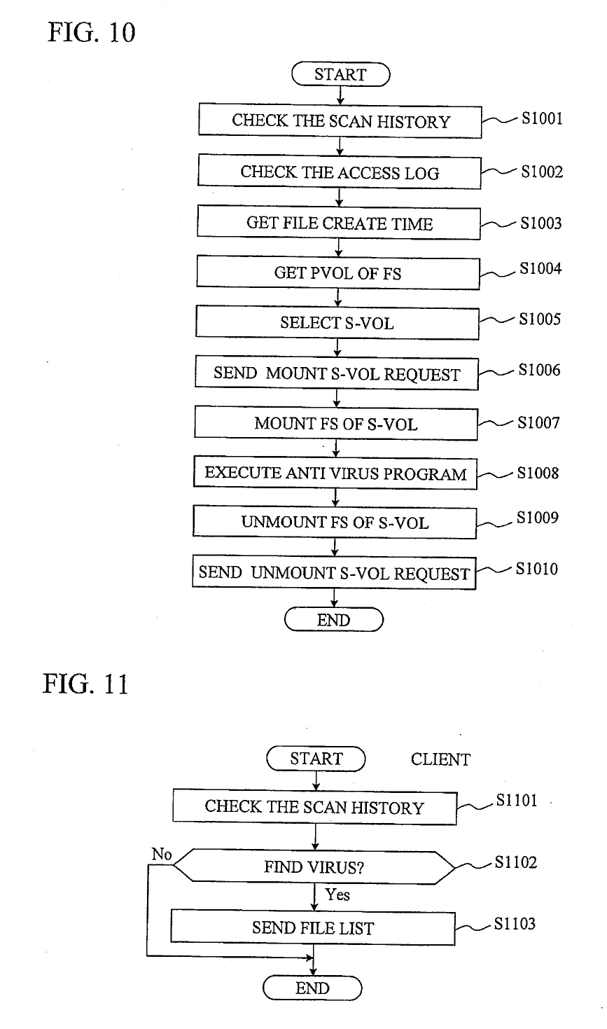

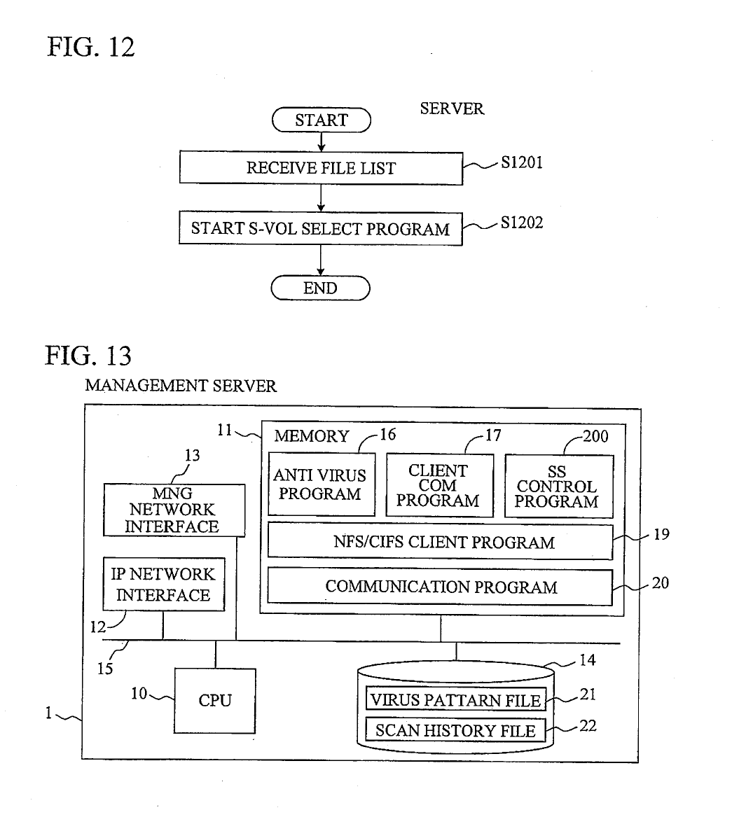

FIG. 10 is a flowchart showing the processing details performed by the secondary volume selection program. The secondary volume selection program selects the secondary volumes 51a, 51b, and 51c of the primary volume 50 corresponding with the file system provided by the NAS system 3 to store the infected file, and performs the anti-virus program 16 for the selected secondary volumes 51a, 51b, and 51c. Note that the secondary volume selection program 18 can be manually booted by the user when the anti-virus program 16 performs the virus scanning for the file system provided by the NAS system 3, and detects and removes the infected file. It can also be booted automatically when the client communication program 17 receives the list of the infected files from the NAS client 2 (refer to FIG. 12).

In FIG. 10, the secondary volume selection program 18 firstly refers to the virus scanning history file 22, and obtains the name of the infected file and the name of the file system where the file is stored (step S1001). Next, the secondary volume selection program 18 requires the NAS system 3 via the management network 7 to transmit the access log file 45 (refer to FIG. 8), obtains the contents of the access log file 45 from the NAS system 3, and extracts the history of the file updated or deleted (step S1002). Note that the NAS system 3, in response to the request from the management server 1, transmits the access log file 45 from the NAS management program 43 to the management server 1. Extracting the history of the file update or delete is performed for the following reasons. That is, if the file is deleted or updated (modified) after the primary volume is replicated to the secondary volume(s), the original file corresponding with the deleted or modified file does not remain in the primary volume (P-VOL), and it has not been scanned for viruses. Therefore, unknown viruses might be included in these files, and their secondary volumes (S-VOLs) must be scanned for viruses. In cases of deletion, whether the reason of the deletion is the infection with the viruses cannot be ascertained, and it becomes the target of the processing considering the security. Meanwhile, in cases of modification, it becomes the target of the processing because the file might have been modified as the virus has been removed by the virus scanning.

Furthermore, the secondary volume selection program 18 extracts the file obtained at S1001 and the history of creating the update file or the deleted file extracted at S1002 from the access log file 45 obtained from the NAS system 3 at S1002, and obtains the creation date and time of each file (step S1003). At this time, the file system to be accessed is specified by the file system name shown by the field 63 of the virus scanning history file 22 or the file system name recorded in the field 112 of the access log file 45.

Next, the secondary volume selection program 18 obtains the name of the primary volume 50 corresponding with the file system accessed from the NAS system 3 at S1003 (step S1004). At this time, in the NAS system 3, the NAS management program 43 refers to the file system management table 42 (refer to FIG. 7), and transmits the name of the primary volume 50 corresponding with the file system required by the management server 1 to the management server 1.

Then, the secondary volume selection program 18 obtains the names of the secondary volumes 51a, 51b, and 51c of the primary volumes 50 of all the volume names obtained at S1004 from the storage device 4 via the management network 7. At this time, the storage device 4 refers to the replication history file 56 and transmits the names of the secondary volumes 51a, 51b, and 51c which are replicated from the primary volume of the volume name specified by the management server 1 and the replication date and time to the management server 1. Then, the secondary volume selection program 18 compares the replication dates and time of the secondary volumes obtained from the storage device 4 with the file creation date and time obtained at S1003, and selects the secondary volumes 51a, 51b, and 51c whose replication dates and time are newer than the file creation date and time as the targets of virus scanning (step S1005).

Next, the secondary volume selection program 18 transmits the request for providing the secondary volumes 51a, 51b, and 51c selected as the targets of virus scanning (mount request) to the NAS system 3 via the management network 7. Then, in the NAS system 3, the NAS management program 43, in response to the relevant mount request, sets the secondary volumes 51a, 51b, and 51c specified by the management server 1 to be provided as the file system, and transmits the file system name to the management server 1 (step S1006).

Furthermore, the secondary volume selection program 18, when receiving the file system name corresponding with the secondary volumes 51a, 51b, and 51c from the NAS system 3 at the step S1006, mounts the file system whose name was received via the IP network 5 (step S1007). Then, the secondary volume selection program 18 issues a command to the anti-virus program 16 for performing virus scanning for the file included in the file system mounted at S1007 and obtained at S1001 and the updated or deleted file extracted at S1002 (step S1008).

When the processing by the anti-virus program 16 is completed, the secondary volume selection program 18 unmounts the file system corresponding with the secondary volumes 51a, 51b, and 51c (step S1009), notifies the NAS system 3 via the management network 6 to stop providing the file system corresponding with the secondary volumes 51a, 51b, and 51c (step S1010). The processing is completed with the completion of the relevant notification. Note that, in the NAS system 3, in response to the relevant notification, the NAS management program 43 follows the notification from the management server 1 and stops providing the file system corresponding with the secondary volumes 51a, 51b, and 51c.

Processing Details of Server Communication Program

FIG. 11 is a flowchart showing the processing performed by the server communication program 29. The server communication program 29 is the program of reporting the list of infected files to the management server 1 when the anti-virus program 28 running in the NAS client 2 detects any infected files in the file system provided by the NAS system 3.

In FIG. 11, the server communication program 29 refers to the virus scanning history file 33 (step S1101), and confirms the presence of history of detecting and removing viruses (step S1102). If there is any history of detecting and removing the viruses, the processing proceeds to S1103, and if not, the processing is completed.

If Yes is selected at the step S1102, the server communication program 29 transmits all the entries of the virus scanning history file 33 to the management server 1 (step S1103).

Note that, in the management server 1, the client communication program 17 receives all the entries of the virus scanning history file 33 transmitted from the server communication program 29.

Processing Details of Client Communication Program

FIG. 12 is a flowchart showing the processing performed by the client communication program 17.

The client communication program 17 firstly receives all the entries of the virus scanning history file 33 from the NAS client 2, and records the received information to the virus scanning history file 22 (step S1201).

Next, the client communication program 17 boots the secondary volume selection program 18 (step S1202).

Summary of First Embodiment

The first embodiment of this invention performs virus scanning for the files which the management server 1 stores in the file system, and records the names of the files where viruses are detected and removed and the dates and time of the deletion and removal. The management server 1, when detecting and removing a virus in the file system corresponding with the primary volume, selects the secondary volume of the primary volume corresponding with the file system where the virus is detected. Then, the management server identifies the file system corresponding with the selected secondary volume, and specifies the file in which the date and time of detecting and removing the viruses is recorded as the target of virus scanning from among the files stored in the identified file system, and performs the virus scanning.

As more specifically described, in the first embodiment, when the NAS system 3 detects an infected file in the file system provided by the NAS system 3, the management server 1 identifies the secondary volumes 51a, 51b, and 51c with the replication dates and time newer than the creation date and time of the infected file from among the secondary volumes 51a, 51b, and 51c of the primary volume 50 corresponding with the file system. Then, virus scanning is performed for the identified secondary volumes 51a, 51b, and 51c. This processing has the effect of removing viruses from the secondary volumes 51a, 51b, and 51c which might include the unknown viruses which failed to be detected and removed at the time of replication, and preventing the invasion of the viruses when recovering (restoring) the file system of the primary volume from the secondary volumes 51a, 51b, and 51c.

Furthermore, by limiting the files whose secondary volumes 51a, 51b, and 51c to be scanned for viruses to the infected files in the file system corresponding with the primary volume and the deleted or updated files, the time for virus scanning can be reduced.

### (2) Second Embodiment

The second embodiment relates to the system of creating the snapshot of the file system as the backup of the NAS system. The second embodiment is described below, by referring to FIGS. 13 to 20. Note that the parts common to the first embodiment are omitted from the description.

System Configuration

The system configuration of this embodiment is omitted from the description as it is common to the system of the first embodiment. The NAS client 2 configuring the system is also common to that of the first embodiment and omitted from the description.

Management Server Configuration

FIG. 13 is a diagram showing the configuration overview of the management server 1 by the second embodiment. As shown in the figure, the management server 1 includes a CPU 10, a memory 11, an IP network interface 12 for the connection with the IP network 5, a management network interface 13 for the connection with the management network, a hard disk 14, and an internal bus 15 for connecting these components.

The memory 11 stores an anti-virus program 16 performing virus scanning for the file system provided by the NAS system 3, a client communication program 17 communicating with the NAS client 2, a snapshot control program 200 selecting the snapshot of the file system where the infected file is stored, an NFS/CIFS client program 19 accessing the file system provided by the NAS system 3, and a communication program 20 for the communication by the communication protocols of the IP network 5 and the management network 7. These programs operate as relevant processing units in collaboration with the CPU 10. For example, the snapshot control program 200 operates as the snapshot processing unit 200 in collaboration with the CPU 10.

Furthermore, the hard disk 14 stores the virus pattern file 21 used by the anti-virus program 16 when detecting viruses and a virus scanning history file 22 for storing the virus detection and removal history by the anti-virus program 16.

NAS System Configuration

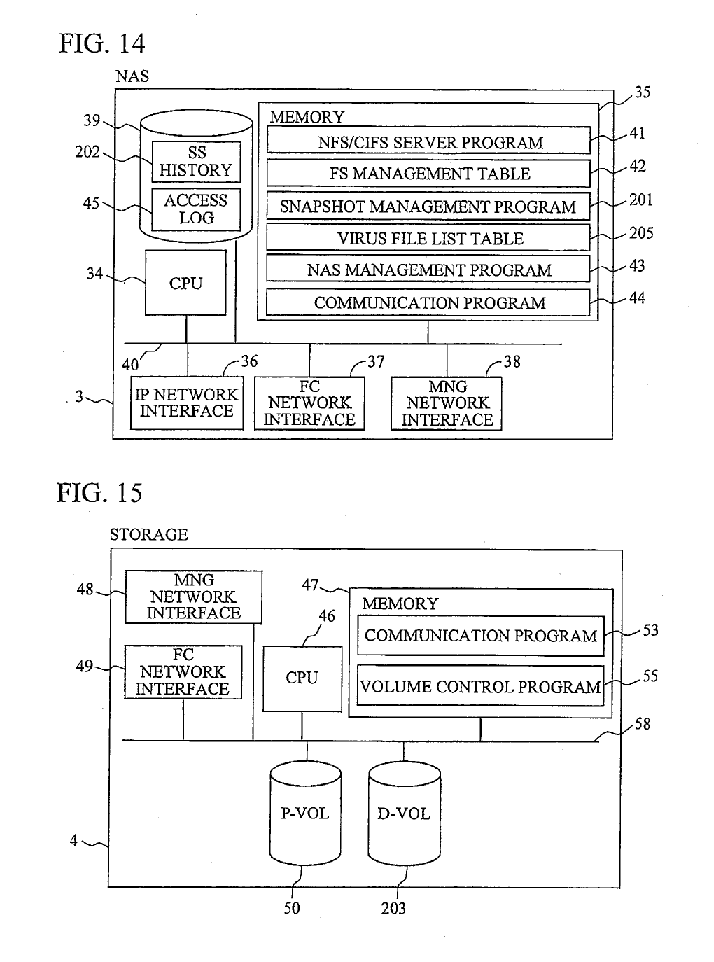

FIG. 14 is a diagram showing the configuration overview of the NAS system 3 by the second embodiment. As shown in the figure, the NAS system 3 includes a CPU 34, a memory 35, an IP network interface 36 for the connection with the IP network 5, an FC network interface 37 for the connection with the FC network 6, a management network interface 38 for the connection with the management network 7, a hard disk 39, and an internal bus 40 for connecting these components.

The memory 35 stores an NFS/CIFS server program 41 for controlling accesses from the management server 1 and the NAS client 2 to the file system provided by the NAS system 3, an NAS management program 43 for controlling the NAS system 3, a snapshot management program 201 for managing snapshots, and a communication program 44 for the communication by the communication protocols of the IP network 5, the FC network 6, and the management network 7. The CPU 34 performs these programs. These programs operate as relevant processing units in collaboration with the CPU 34. For example, the NFS/CIFS server program 41 operates as the NFS/CIFS server processing unit 41 in collaboration with the CPU 34.

The memory 35 stores a file system management table 42 for managing and storing the correspondence of the file system provided by the NAS system 3 and the volumes provided by the storage device 4 and a virus infection file list table 205 for managing the names of infected files.

The hard disk 39 stores an access log file 45 recording the access history from the NAS client 2 to the file system provided by the NAS system 3 and a snapshot history file 202 recording the creation (acquisition) history of snapshots. Recording the access history to the access log file 45 is performed by the NFS/CIF server program 41, and recording the snapshot creation history to the snapshot history file 202 is performed by the snapshot management program 201.

Storage Device Configuration

FIG. 15 is a diagram showing the configuration overview of the storage device 4 by the second embodiment. As shown in the figure, the storage device 4 includes a CPU 46, a memory 47, an IP network interface 49 for the connection with the IP network 5, a management network interface 48 for the connection with the management network 7, a primary volume (P-VOL) 50, a differential volume (D-VOL: the saved volume of the (part of the) original data) 203, and an internal bus 58 for connecting these components.

The primary volume 50 is the volume mounted and used by the NAS system 3. The NAS system 3 provides the mounted primary volume as a file system. The differential volume 203 is the volume for storing the data stored in the write target when write is performed to the primary volume 50. The snapshot management program 201 combines the data stored in the primary volume 50 and in the differential volume 203 to create a snapshot 204.

The memory 47 stores a communication program 53 for the communication by the communication protocols of the FC network 6 and the management network 7, and a volume control program 55 for controlling accesses to the primary volume 50 and the differential volume 203. These programs operate as relevant processing units in collaboration with the CPU 46. For example, the volume control program 55 operates as the volume control unit 55 in collaboration with the CPU 46.

Creating Snapshots

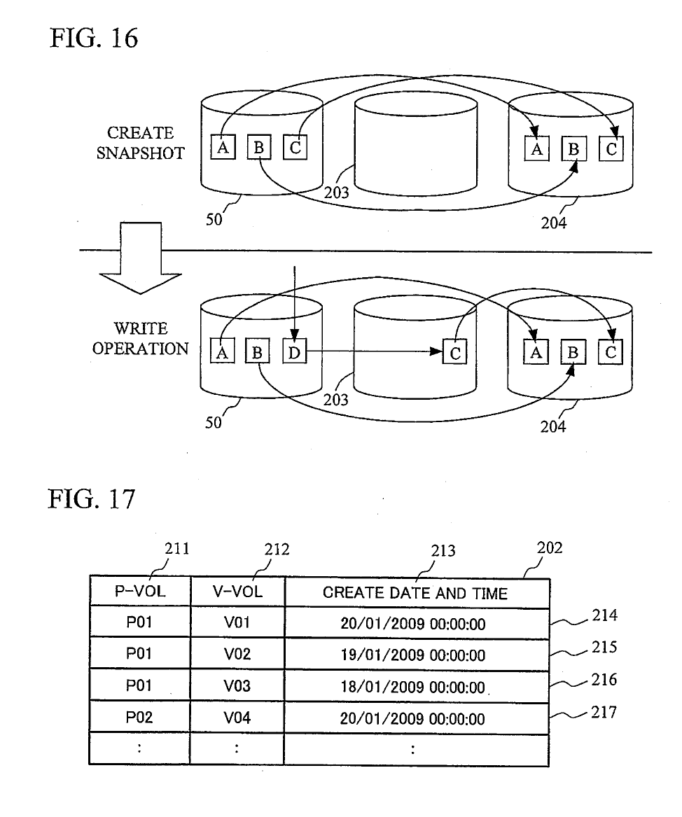

FIG. 16 is a diagram showing the relationship between data saving of the primary volumes 50 to the differential volume 203 and the data stored in the snapshot 204. By referring to FIG. 16, the method of creating the snapshot 204 from the primary volume 50 and the differential volume 203 is described below.

Once the command for creating a snapshot is issued, the snapshot 204 is created using the data stored in the primary volume 50. FIG. 16 shows the example in which the data “A,” “B,” and “C” are stored in the primary volume 50, and the snapshot 204 provides “A,” “B,” and “C” by referring to the data “A,” “B,” and “C” in the primary volume 50. No write to the snapshot 204 itself is allowed, and the snapshot 204 has the function as the pointer to the primary volume.

Next, for performing a write operation to the primary volume 50, the data stored in the write target is saved in the differential volume 203, and then data is written to the primary volume 50. The snapshot 204 is created with reference to the data not written to the primary volume 50 and the data stored in the differential volume 203. That is, in the example of FIG. 16, for writing “D” to the area where “C” of the primary volume 50 is stored, firstly, “C” is saved to the differential volume 203, and “D” is written. The snapshot 204 is created of “A” and “B” of the primary volume 50 and “C” of the differential volume 203. Therefore, even after “D” is written, the snapshot 204 is supposed to point “A,” “B,” and “C.” This method enables the snapshot 204 of the primary volume 50 at the time of creating the snapshot 204 to be provided. Note that the snapshot management program 201 performs the series of processing related to the snapshot 204.

Example of Snapshot History File

FIG. 17 is a diagram showing an example form of the snapshot history file 202. As shown in the figure, the snapshot history file 202 includes the field 211 recording the name of the primary volume 50 which has created the snapshot 204, the field 212 recording the name of the snapshot 204 created for the primary volume 50 in the field 211, and the field 213 recording the date and time of creating the snapshot 204 in the field 213.

For example, the entries of the numerals 214, 215, and 216 show that, for the primary volume “P01,” the snapshots “V01,” “V02,” and “V03” were created at 00:00:00 on Jan. 20, 2009, at 00:00:00 on Jan. 19, 2009, and at 00:00:00 on Jan. 18, 2009, respectively.

Virus Infection File List Table

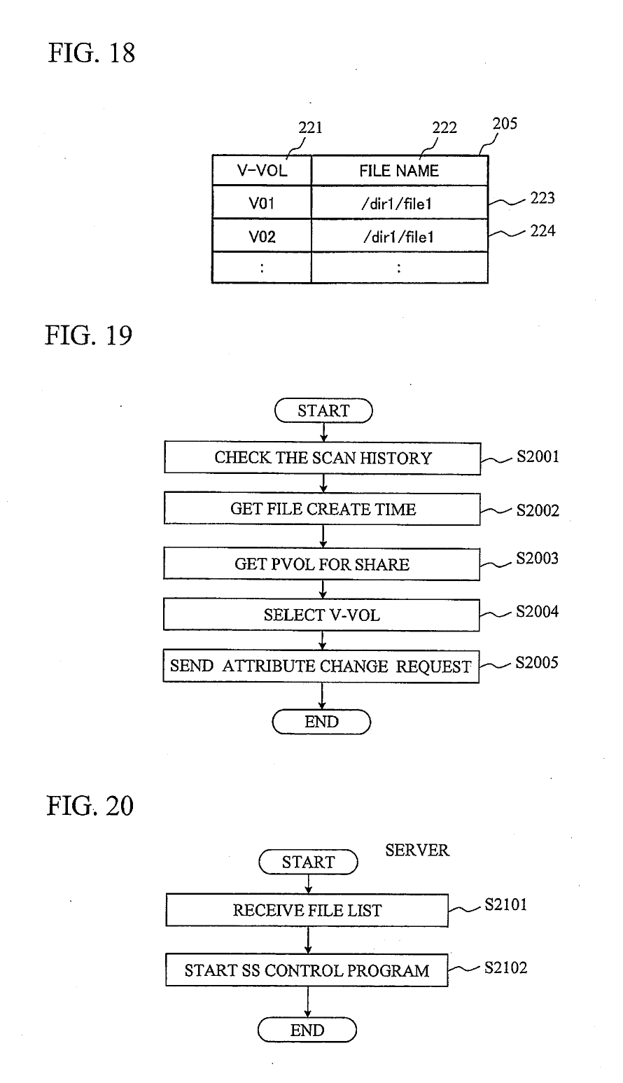

FIG. 18 is a diagram showing an example form of the virus infection file list table 205. As shown in the figure, the virus infection file list table 205 includes the field 221 recording the name of the snapshot 204 and the field 222 recording the names of the infected files in the snapshot in the field 221.

For example, the entry of the numeral 223 shows that the snapshot “V01” has an infected file “/dir1/file1.” The snapshot management program 201 discloses the files of the snapshot 204 recorded in the virus infection file list table 205 with the attributes “unreadable” or “not executable.” This processing prevents the recovery executed by the infected files and the invasion of the viruses in the file system.

Processing Details of Snapshot Control Program

FIG. 19 is a flowchart showing the processing of the snapshot control program. The snapshot control program 200 selects the snapshot 204 corresponding with the file system provided by the NAS system 3 where the infected file is stored, and performs the processing of changing the attribute of the infected file to “unreadable” or “not executable.”

Note that, when the anti-virus program 16 performs the virus scanning for the file system provided by the NAS system 3, detects the infected file, and removes it, the snapshot control program 200 is manually executed. Furthermore, the snapshot control program 200 is automatically booted when the client communication program 17 receives the list of infected files from the NAS client 2. The processing details of the snapshot control program 200 are described below referring to FIG. 19.

According to FIG. 19, the snapshot control program 200 firstly refers to the virus scanning history file 22 and obtains the names of the infected files and the name of the file system where those files are stored (step S2001).

Furthermore, the snapshot control program 200 accesses the file system provided by the NAS system 3 via the IP network 5, and obtains the creation dates and time of the files obtained at S2001 (step S2002). At this time, the file system to be accessed has the name shown in the field 63 of the virus scanning history file 22.

Next, the snapshot control program 200 obtains the name of the primary volume 50 corresponding with the file system accessed at S2002 from the NAS system 3 via the management network (step S2003). Note that, in the NAS system 3 at this time, the NAS management program 43 refers to the file system management table 42 and transmits the name of the primary volume 50 corresponding with the file system required by the management server 1 to the management server 1.

The snapshot control program 200 obtains the names and the replication dates and time of the snapshots 204 of all the primary volumes 50 of all the volumes obtained at S2003 from the NAS system 3 via the management network 7. Note that, in the NAS system 3 at this time, the snapshot management program 201 refers to the snapshot history file 202, and transmits the name and the acquisition date and time of the snapshot 204 of the primary volume 50 with the volume name specified by the management server 1 to the management server 1. Then, the snapshot control program 200 compares the acquisition dates and time of the snapshot obtained from the NAS system 3 with the date and time of creating the file obtained at S2002, and selects the snapshot 204 as the target of access restriction whose acquisition date and time are newer than the file creation date and time (step S2004).

Furthermore, the snapshot control program 200 transmits the command via the management network 7 to the NAS system 3 for changing the attributes of the files obtained at S2001 corresponding with the snapshot 204 selected as the targets of access restriction to “unreadable” or “not executable” (not changing the snapshots themselves) (step S2005). In the NAS system 3 at this time, the NAS management program 43 receives the command from the management server 1, and records the specified snapshot 204 and the corresponding files to the virus infection file list table 205.

Processing Details of the Client Communication Program

FIG. 20 is a flowchart showing the processing of the client communication program. The client communication program 17 boots the snapshot control program 200 when all the entries of the virus scanning history file 33 are received from the server communication program 29 operating in the NAS client 2.

FIG. 20 shows that the client communication program 17 receives all the entries of the virus scanning history file 33 from the NAS client 2, and records the received information to the virus scanning history file 22 (step S2101).

Next, the client communication program 17 boots the snapshot control program 200 (step S2102).

In accordance with this booting process, the snapshot control program 200 performs the processing of the above-mentioned FIG. 19.

Summary of Second Embodiment

By the second embodiment, the NAS system 3 provides at least one snapshot of the file system. Furthermore, the management server 1 performs virus scanning for the files stored in the file system, and records the names of the files where the viruses are detected and removed and the detection and removal dates and time. Then, the management server, when detecting and removing the virus, identifies the snapshot corresponding with the file system where the virus is detected, and notifies the 3 to perform access restriction for the identified snapshot. The NAS system 3 restricts accesses to the snapshot specified by the management server 1.

As more specifically described, by the second embodiment, when an infected file is detected in the file system provided by the NAS system 3, the management server 1 identifies the snapshot 204 whose creation date and time is newer than the creation date and time of the infected file from among the snapshots 204 corresponding with the file system, and changes the attribute of the infected file corresponding with the identified snapshot to “unreadable” or “not executable:” This processing has the effect of preventing the recovery executed by the infected files of the snapshot 204 and the invasion of the viruses in the file system.

This processing also has the effect of preventing the spreading of the viruses as accesses from the NAS client 2 to the virus infection files in the snapshot 204 can be prevented.

### (3) Third Embodiment

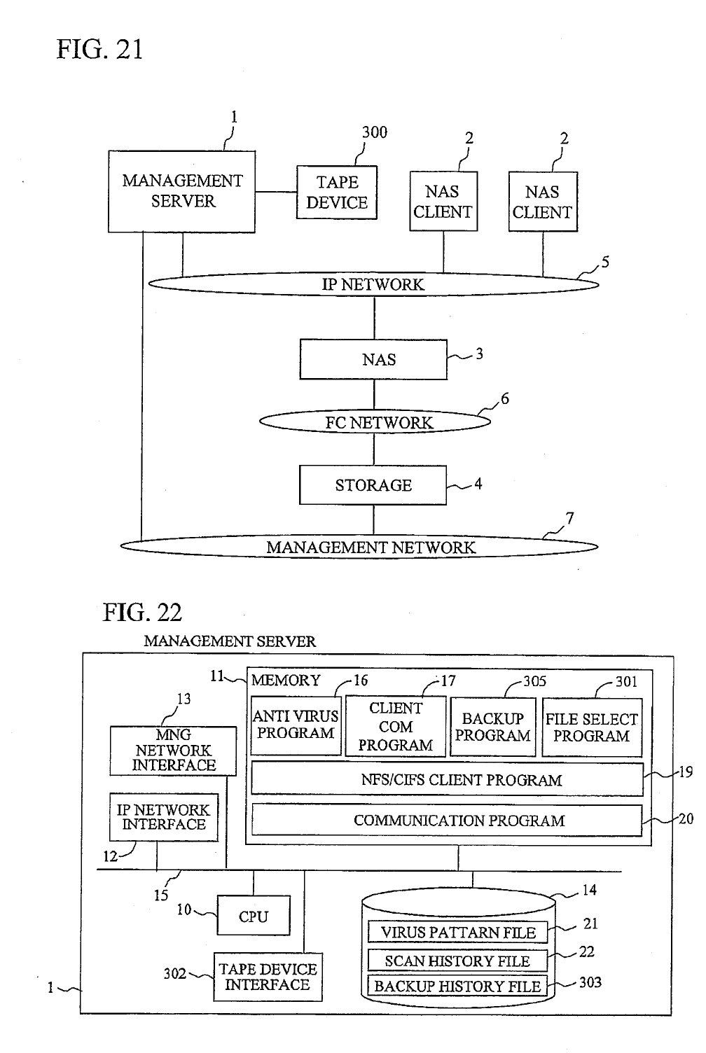

The third embodiment relates to the system for obtaining backups in external devices such as tape devices. The third embodiment does not include backups in the storage device but has secondary volumes (S-VOLs) in the external device (such as a tape device) connected with the management server. As the tape device cannot be scanned for viruses, the virus scanning is performed after the data is restored to the file system. The third embodiment is described by referring to FIGS. 21 to 25. Note that the parts common to the first and second embodiments are omitted from the description.

System Configuration

FIG. 21 is a diagram showing the configuration overview of the storage system by the third embodiment of this invention. As shown in the figure, the storage system of this embodiment includes a management server 1 including a tape device 300, at least one NAS system 3, at least one storage device 4, a NAS client 2 performing a file access to the NAS system 3, an IP (Internet Protocol) network 5 for connecting the management server 1, the NAS system 3 and the NAS client 2, a management network 7 for connecting the management server 1, the NAS system 3 and the storage device 4, an FC (Fibre Channel) network 6 to which the NAS system 3 and the storage device 4 are connected. Note that this embodiment includes three networks i.e. the IP network 5, the FC network 6 and the management network 7 for convenience, but the types of networks are not limited to them. One network may also be permitted. Furthermore, as the NAS client 2 in this embodiment is the same as the first embodiment, the description is omitted. The storage device 4 is also omitted from the description as it can be in any of the configurations described in the first and second embodiments.

Management Server Configuration

FIG. 22 is a diagram showing the configuration overview of the management server 1 by the third embodiment. As shown in the figure, the management server 1 includes a CPU 10, a memory 11, an IP network interface 12 for the connection with the IP network 5, a management network interface 13 for the connection with the management network, a hard disk 14, a tape device interface 302 for the connection with the tape device 300, and the internal bus 15 for connecting these components.

The memory 11 stores an anti-virus program 16 performing virus scanning for the file system provided by the NAS system 3, a client communication program 17 communicating with the NAS client 2, a backup program 305 creating the backup of the file system provided by the NAS system 3 to the tape device 300 and restoring the backup data of the tape device 300 to the file system provided by the NAS system 3, a file selection program 301 for selecting the file to be scanned for viruses from among the files restored to the file system provided by the NAS system 3, an NFS/CIFS client program 19 for accessing the file system provided by the NAS system 3, and a communication program 20 for the communication by the communication protocols of the IP network 5 and the management network 7. These programs operate as relevant processing units in collaboration with the CPU 10, for example, the backup program 305 operates as the backup processing unit 305 in collaboration with the CPU 10.

The hard disk 14 stores a virus pattern file 21 used by the anti-virus program 16 when detecting viruses and a virus scanning history file 22 for storing the virus detection and removal history by the anti-virus program 16, a backup history file 303 managing and storing the history of the creation of the backup of the file system provided by the NAS system 3 by the backup program 305. Note that, though not shown in the figure, the memory 11 stores an operating system.

NAS System Configuration

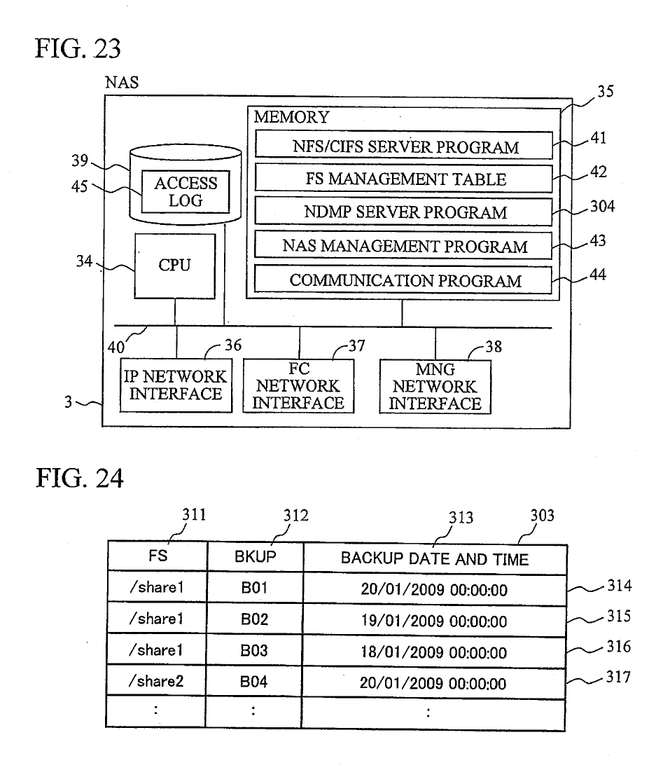

FIG. 23 is a diagram showing the configuration overview of the NAS system 3 by the third embodiment. As shown in the figure, the NAS system 3 includes a CPU 34, a memory 35, an IP network interface 36 for the connection with the IP network 5, an FC network interface 37 for the connection with the FC network 6, a management network interface 38 for the connection with the management network 7, a hard disk 39 and an internal bus 40 for connecting these components.

The memory 35 stores an NFS/CIFS server program 41 controlling the accesses from the management server 1 and the NAS client 2 to the file system provided by the NAS system 3, an NDMP (Network Data Management Server) server program 304 operating in collaboration with the backup program 305 operating the backup and restore of the file system in the management server 1, an NAS management program 43 for controlling the NAS system 3 and a communication program 44 for the communication by the communication protocols of the IP network 5, the FC network 6 and the management network 7. These programs operate as relevant processing units in collaboration with the CPU 34. For example, the NAS management program 43 operates as the NAS management unit 43 in collaboration with the CPU 34.

The memory 35 also stores a file system management table 42 storing the correspondence of the file systems provided by the NAS system 3 with the volumes provided by the storage device 4.

The hard disk 39 stores an access log file 45 recording the access history from the NAS client 2 to the file system provided by the NAS system 3 to the NAS client 2. The recording of the access history to the access log file 45 is performed by the NFS/CIFS server program 41.

Example of Backup History File

FIG. 24 is a diagram showing an example form of the backup history file 303. As shown in the figure, the backup history file 303 is configured of the field 311 recording the backed up file system, the field 312 recording the name of the backup data of the file system in the field 311, and the field 313 recording the date and time of obtaining the backup data in the field 312.

For example, the entries of the numerals 314, 315, and 316 show that the backup data “B01,” “B02,” and “B03” of the file system “/share1” were obtained at 00:00:00 on Jan. 20, 2009, at 00:00:00 on Jan. 19, 2009, and at 00:00:00 on Jan. 18, 2009, respectively.

Processing Details of File Selection Program

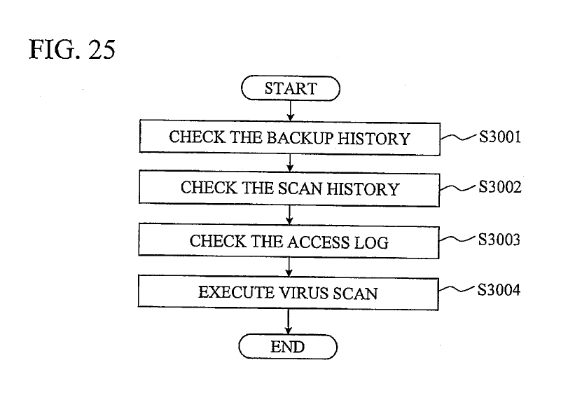

FIG. 25 is a flowchart showing the processing details of the file selection program 301. The file selection program 301 selects the file to be scanned for viruses from among the files restored in the file system provided by the NAS system 3. Note that the file selection program 301 is manually booted when the backup data of the tape device 300 is restored in the file system provided by the NAS system 3.

FIG. 25 shows that the file selection program 301 firstly refers to the backup history file 303, and obtains the date and time of obtaining the restored backup data and the file system name of the backup data (step S3001).

Next, the file selection program 301 refers to the virus scanning history file 22, and obtains the name of the infected file whose creation date and time is older than the acquisition date and time of the backup data restored at S3001 (step S3002).

Then, the file selection program 301 is connected with the NAS system 3 via the management network 7, obtains the contents of the access log file 45, and extracts the update and delete history of the files accessed before the acquisition date and time of the backup data restored at S3001 (step S3003). Note that, in the NAS system 3 at this time, in response to the request of the file selection program 301, the NAS management program 43 transmits the access log file 45 to the management server.

Finally, the file selection program 301 performs virus scanning using the anti-virus program 16 for the files obtained at S3002 and the files of the history extracted at S3003 from among the files stored in the restored file system (step S3004).

Summary of Third Embodiment

As mentioned above, the third embodiment of this invention, when restoring the backed up data in the external device to the file system provided by the NAS system 3, performs virus scanning only for the files infected, created or updated before the execution of the restore. By this method, after the restore, not all the files stored in the file system but the files which might have been infected are scanned for viruses, and therefore, the time after the recovery until the file system becomes available can be reduced.

### (4) Fourth Embodiment

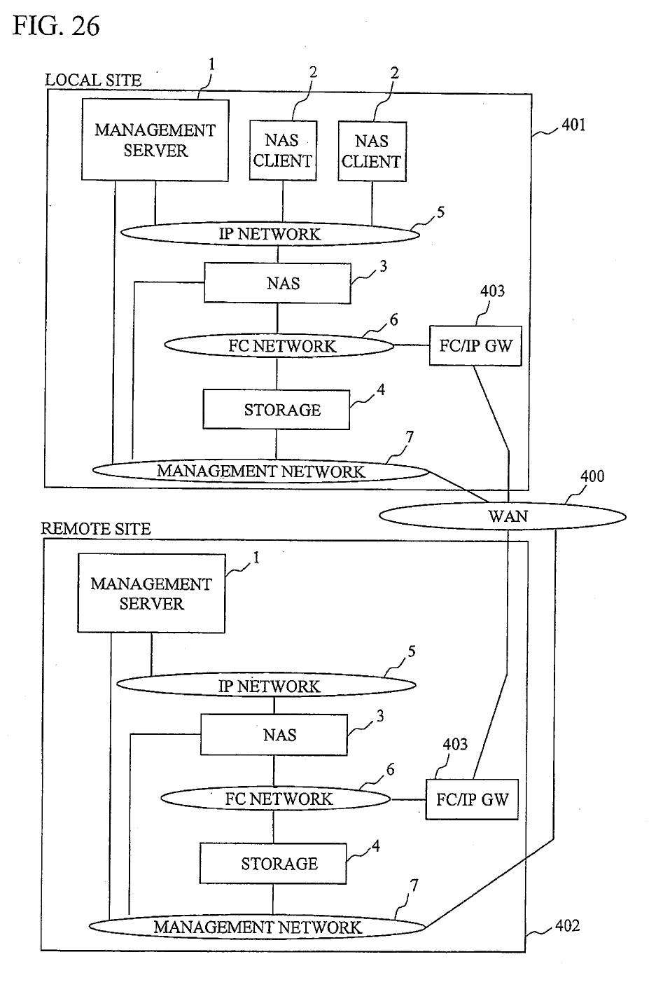

The fourth embodiment relates to the system of physically replicating data of the volume corresponding with the file system (hereinafter referred to as a primary volume (P-VOL)) to another volume (hereinafter referred to as a secondary volume (S-VOL)) and creating a remote copy of the primary volume and the secondary volume to the primary volume and the secondary volume corresponding with the file system provided by the NAS system at a remote site. This embodiment is described below, referring to FIGS. 26 to 30. Note that the parts same as the first to third embodiments are omitted from the description.

System Configuration

FIG. 26 is a diagram showing the configuration overview of the storage system by the fourth embodiment of this invention.

As shown in the figure, the storage system of this embodiment includes a local site 401 and a remote site 402 installing the NAS system 3 of the remote copy target connected by the WAN (Wide Area Network) 400.

Each of the local site 401 and the remote site 402 includes a management server 1, at least one NAS system 3, at least one storage device 4, an IP (Internet Protocol) network 5 for connecting the management server 1 and the NAS system 3, a management network 7 for connecting the management server 1, the NAS system 3, and the storage device 4, an FC (Fibre Channel) network 6 for connecting the NAS system 3 and the storage device 4, and an FC/IP gateway 403 connected with the FC network 6 and the WAN 400.

The WAN 400 is connected with the management network 7 and the FC network 6. In the local site 401, in addition to the above-mentioned configuration, the NAS client 2 making file access to the NAS system 3 is connected with the IP network 5.

Note that the configuration of the NAS client 2 and the NAS system 3 in this embodiment is omitted from the description as it is the same as that of the first embodiment. Furthermore, this embodiment includes three networks i.e. the IP network 5, the FC network 6, and the management network 7 for convenience, but the types of networks are not limited to them. Only one network may also be permitted. In addition, the FC/IP gateway 403 is the device for converting the FC protocol and the IP protocol. Therefore, if the network connecting the NAS system 3 and the storage device 4 and the WAN 400 can be communicated by the same protocol, the FC/IP gateway 403 is not required.

In each of the local site 401 and the remote site 402, the same primary volume (P-VOL) and the secondary volume (S-VOL) are maintained. This enables the volumes to be restored at the remote site 402 even if they are corrupted at the local site 401. As the secondary volume of the remote site 402 includes the older information (past information) than the primary volume of the local site 401, the volume at the local site 401 can be restored to the status before the corruption.

Management Server Configuration

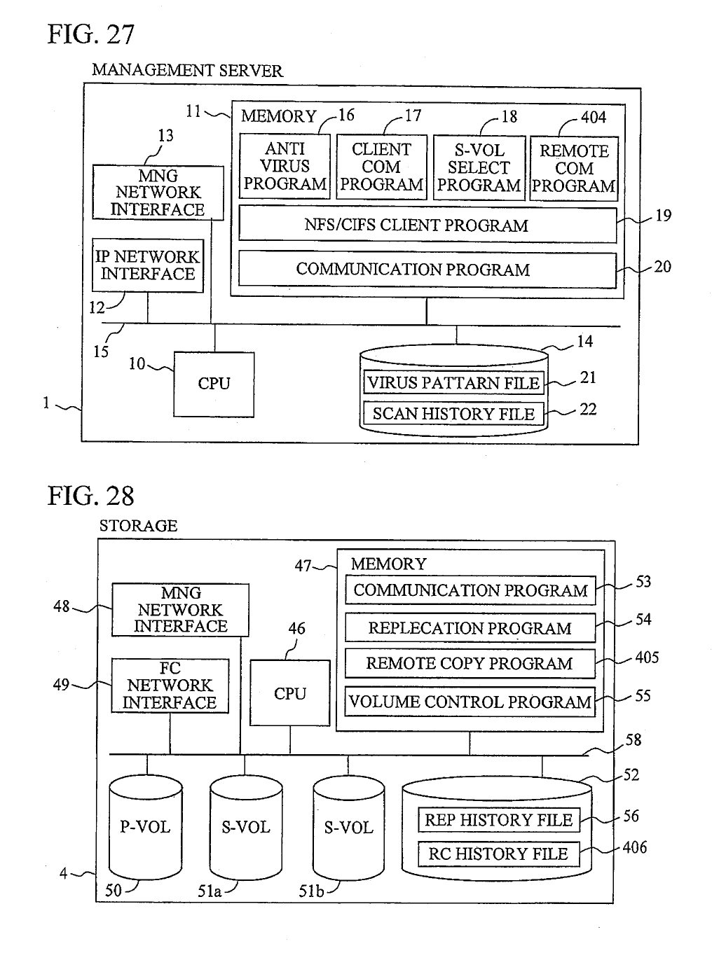

FIG. 27 is a diagram showing the configuration overview of the management server 1 by the fourth embodiment.

As shown in the figure, the management server 1 includes a CPU 10, a memory 11, an IP network interface 12 for the connection with the IP network 5, a management network interface 13 for the connection with the management network, a hard disk 14 and an internal bus 15 for connecting these components.

The memory 11 stores an anti-virus program 16 performing virus scanning for the file system provided by the NAS system 3, a client communication program 17 communicating with the NAS client 2, a secondary volume selection program 18 for selecting the secondary volume corresponding with the primary volume of the file system storing the infected file, a remote communication program 404 for communicating with the management server 1 of the connected site, an NFS/CIFS client program 19 accessing the file system provided by the NAS system 3, and a communication program 20 for the communication by the communication protocols of the IP network 5 and the management network 7. These programs operate as relevant processing units in collaboration with the CPU 10. For example, the secondary volume selection program 18 operates as the secondary volume selection processing unit 18 in collaboration with the CPU 10.

The hard disk 14 stores the virus pattern file 21 used by the anti-virus program 16 when scanning for viruses and a virus scanning history file 22 for storing the virus detection and removal history by the anti-virus program 16.

Note that, though not shown in the figure, the memory 11 stores an operating system.

Storage System Configuration

FIG. 28 is a diagram showing the configuration overview of the storage device by the fourth embodiment.

As shown in the figure, the storage device 4 includes a CPU 46, a memory 47, an FC network interface 49 for the connection with the IP network 5, the management network interface 48 for the connection with the management network 7, a primary volume 50, secondary volumes 51a and 51b, a hard disk 52, and an internal bus 58 for connecting these components.

The primary volume 50 is the volume mounted and used by the NAS system 3. The NAS system 3 provides the mounted primary volume 50 as a file system. The secondary volumes 51a and 51b are the volumes replicated from the data stored in the primary volume 50 at a certain point of time. The secondary volumes are created by replicating the data stored in the primary volume at separate points of time respectively.

The memory 47 stores a communication program 53 for the communication by the communication protocols of the FC network 6 and the management network 7, a remote copy program 405 performing a remote copy of the primary volume 50 and the secondary volumes 51a and 51b to the primary volume 50 and the secondary volumes 51a and 51b at the storage device 4 of the connected site, a replication program 54 for replicating the primary volume 50 to the secondary volumes 51a and 51b, and a volume control program 55 controlling accesses to the primary volume 50 to the secondary volumes 51a and 51b. These programs operate as relevant processing units in collaboration with the CPU 46. For example, the replication program 54 operates as the replication processing unit 54 in collaboration with the CPU 46.

The hard disk 52 stores a replication history file 56 for managing and storing the replication history by the replication program 54 from the primary volume 50 to the secondary volumes 51a and 51b, and a remote copy history file 406 for managing and storing the remote copy history by the remote copy program 405 from the primary volume 50 and the secondary volumes 51a and 51b to the primary volume 50 and the secondary volumes 51a and 51b at the storage device 4 of the connected site.

The remote copy program 405 of the local site 401 transmits the data stored in the primary volume 50 and the secondary volumes 51a and 51b of the storage device 4 of the local site 401 to the remote copy program 405 of the remote site 402. Furthermore, if the volumes to be the source of the remote copy are the secondary volumes 51a and 51b, the information of the entry which is the names of the secondary volumes 51a and 51b as the remote copy target and are recorded to the field 122 of the replication history file 56 is transmitted to the remote copy program 405 of the remote site 402.

Meanwhile, the remote copy program 405 of the remote site 402 stores the data stored in the primary volume 50 and the secondary volumes 51a and 51b received from the remote copy program 405 of the local site 401 in the primary volume 50 and the secondary volumes 51a and 51b of the remote site 402, as well as records the information of the replication history file 56 received from the remote copy program 405 of the local site 401 to the replication history file 56 of the remote site 402. Note that, when the remote copy is completed, the remote copy program 405 records the result of performing the remote copy to the remote copy history file 406.

Example of Virus Scanning History Files

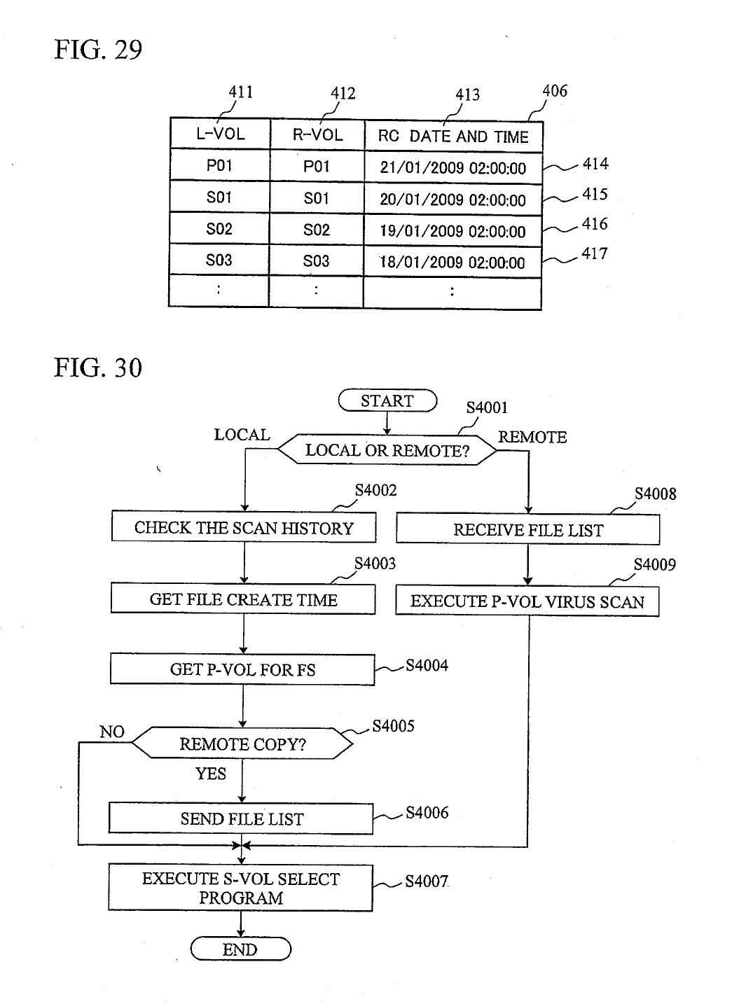

FIG. 29 is a diagram showing an example form of the remote copy history file 406.

As shown in the figure, the remote copy history file 406 includes the field 411 for recording the names of the primary volume 50 and the secondary volumes 51a and 51b, the field 412 recording the names of the primary volume 50 and the secondary volumes 51a and 51b of the remote site 402 created by the remote copy from the volumes in the field 411, the field 413 recording the date and time of performing the remote copy of the volumes of the field 411 to the volumes of the field 412.

For example, the entry of the numeral 414 shows that the volume “P01” of the local site 401 was copied to the volume “P01” of the remote site 402 at 02:00:00 on Jan. 21, 2009.

Processing Details of Remote Communication Program

FIG. 30 is a flowchart showing the processing details of the remote communication program 404. By the remote communication program 404, operations such as confirming the necessity of performing the virus scanning at the remote site 402, virus scanning at the remote site 402 and others are performed. Note that, at the start of the remote communication program 404, whether to perform the program at the local site 401 or the remote site 402 is specified.

FIG. 30 shows that the remote communication program 404 determines whether its own site operates as the local site 401 or as remote site 402 (step S4001). Note that the remote communication program 404 is supposed to recognize as which site its own site operates.

If the result of the determination at S4001 shows that the program operates at the local site 401, the remote communication program 404 performs the steps S4002 to S4006, then performs S4007, and completes the processing. Meanwhile, if the result of the determination at S4001 shows that the program operates at the remote site 402, the remote communication program 404 performs the steps S4008 and S4009, then performs S4007, and completes the processing.

Firstly, the processing for the operations at the local site 401 (S4002 to S4007) is described below.

The remote communication program 404 of the local site 401 refers to the virus scanning history file 22, and obtains the names of the infected files and the name of the file system storing the files (step S4002).

Furthermore, the remote communication program 404 accesses the file system provided by the NAS system 3 via the IP network 5, and obtains the creation date and time of the file obtained at S4002 (step S4003). Note that the file system accessed in this case has the name shown by the field 63 of the virus scanning history file 22.

Next, the remote communication program 404 obtains the name of the primary volume 50 corresponding with the file system obtained at S4002 from the NAS system 3 via the management network (step S4004). Note that, in the NAS system 3 at this time, in response to the request of the remote communication program 404, the NAS management program 43 refers to the file system management table 42 and transmits the name of the primary volume 50 corresponding with the file system requested by the management server 1 to the management server 1.

Then, the remote communication program 404 refers to the remote copy history file 406 and checks if the volume with the name obtained at S4004 became the remote copy target at the date and time newer than the creation date and time of the file obtained at S4003 (step S4005). If the remote copy was not performed, the processing proceeds to S4007. Meanwhile, if the remote copy was performed, the processing proceeds to S4006.

If the result is “Yes” at S4005, the remote communication program 404 transmits the names of all the files obtained at S4002 and the file system (the names of the files and the file system requiring virus scanning) to the remote communication program 404 of the remote site 402 via the management network 7 and the WAN 400, and makes the processing proceed to S4007 (step S4006).

The remote communication program 404 boots the secondary volume selection program 18 of the local site 401 and completes the processing (step S4007).

Next, the processing for the operations at the remote site 402 (S4008, S4009 and S4007) is described below.

The remote communication program 404 at the remote site 402 receives the names of the files and the file system transmitted from the remote communication program 404 of the local site 401 (step S4008).

Next, the remote communication program 404 performs virus scanning using the anti-virus program 16 for the files with the file names received at S4008, stored in the file system with the file system name received at S4008 provided by the NAS system 3 of the remote site 402 (step S4009).

Then, the remote communication program 404 boots the secondary volume selection program 18 at the remote site 402 and completes the processing (step S4007).

Note that the processing details of the secondary volume selection program 18 are omitted from the description as they are the same as the first embodiment.

In this embodiment, the management servers 1 are installed in the local site 401 and the remote site 402 respectively, and the management server 1 of the remote site 402 performs virus scanning for the NAS system 3 of the remote site 402. However, the management server 1 of the local site 401 may also be permitted to perform virus scanning for the NAS system 3 of the remote site 402.

Summary of Fourth Embodiment

As mentioned above, by the fourth embodiment of this invention, if an infected file is detected in the file system provided by the NAS system 3 of the local site 401, the management server 1 of the local site 401 identifies the secondary volumes 51a and 51b with the replication date newer than the creation dates and time of the infected file from among the secondary volumes 51a and 51b of the primary volume 50 corresponding with the file system, and performs virus scanning for the identified secondary volumes 51a and 51b. The same virus scanning is also performed for the primary volume 50 and the secondary volumes 51a and 51b created by the remote copy at the remote site 402. This enables the removal of the viruses not only from the secondary volumes 51a and 51b at the local site 401 including unknown viruses which failed to be detected or removed at the time of replication but also from the secondary volumes 51a and 51b at the remote site 402 including unknown viruses which failed to be detected or removed at the time of remote copy. This embodiment also has the effect of preventing the invasion of viruses when recovering the file system of the primary volume from the secondary volumes 51a and 51b of the local site 401 and the primary volume and secondary volumes 51a and 51b of the remote site 402.

### (5) Fifth Embodiment

The fifth embodiment relates to the system of creating a snapshot of the file system, creating the remote copy of the data stored in the file system to the file system provided by the NAS system at a remote site, and at the same time obtaining the snapshot by the NAS system at the remote site.

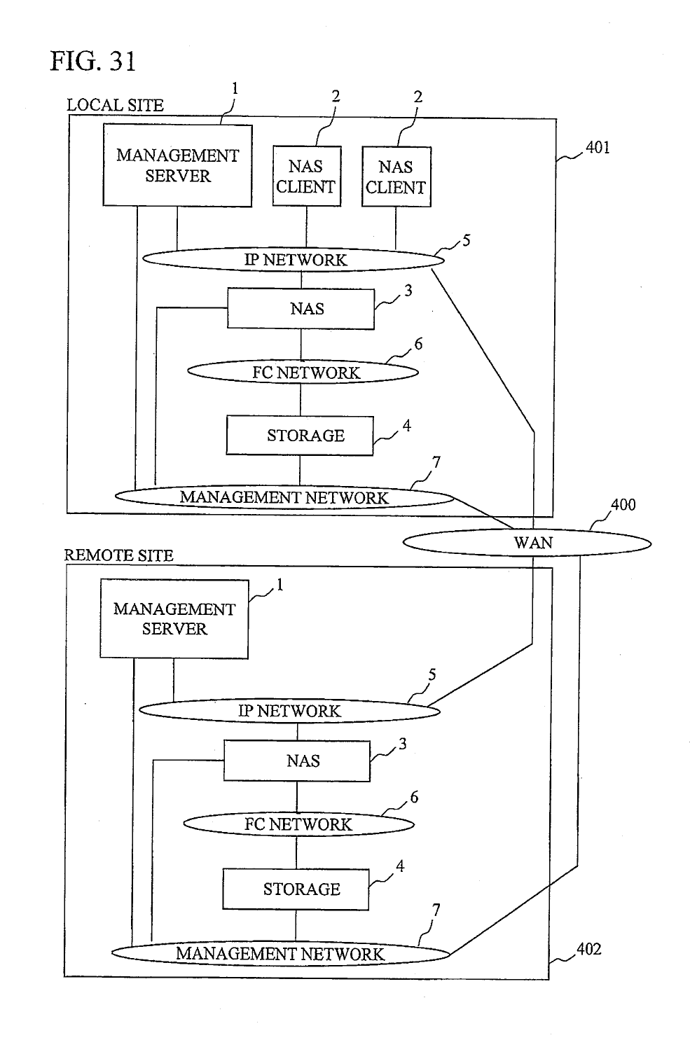

The fifth embodiment is described below, by referring to FIGS. 31 to 35. Note that the parts common to the first to fourth embodiments are omitted from the description.

System Configuration

FIG. 31 is a diagram showing the configuration overview of the storage system by the fifth embodiment of this invention. As shown in the figure, in the system of this embodiment, the local site 401 and the remote site 402 where the NAS system 3 is installed are connected via the WAN (Wide Area Network) 400.

Each of the local site 401 and the remote site 402 includes a management server 1, at least one NAS system 3, at least one storage device 4, an IP (Internet Protocol) network 5 connecting the management server 1 and the NAS system 3, a management network 7 for connecting the management server 1, the NAS system 3 and the storage device 4, an FC (Fibre Channel) network 6 for connecting the NAS system 3 and the storage device 4, and a WAN 400. With the WAN 400, the management network 7 and the IP network 5 are connected. In the local site 401, in addition to the above-mentioned configuration, the NAS client 2 performing the file access for the NAS system 3 is connected with the IP network 5. The NAS client 2 and the NAS system 3 are omitted from the description as they are the same as the second embodiment.

Management Server Configuration

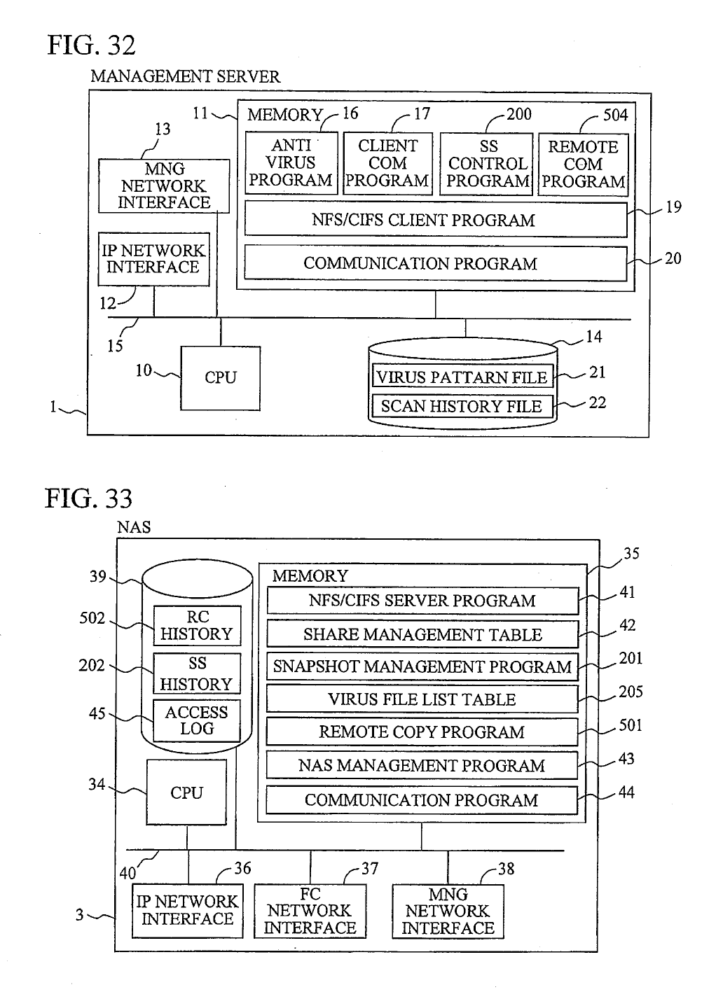

FIG. 32 is a diagram showing the configuration overview of the management server by the fifth embodiment.

As shown in the figure, the management server 1 includes a CPU 10, a memory 11, an IP network interface 12 for the connection with the IP network 5, a management network interface 13 for the connection with the management network, a hard disk 14, and an internal bus 15 for connecting these components.

The memory 11 stores an anti-virus program 16 performing virus scanning for the file system provided by the NAS system 3, a client communication program 17 communicating with the NAS client 2, a snapshot control program 200 for selecting the snapshot of the file system storing the infected file, a remote communication program 504 for communicating with the management server 1 of the connected site, an NFS/CIFS client program 19 accessing the file system provided by the NAS system 3, and a communication program 20 for the communication by the communication protocols of the IP network 5 and the management network 7. These programs operate as relevant processing units in collaboration with the CPU 10. For example, the snapshot control program 200 operates as the snapshot control unit 200 in collaboration with the CPU 10.

The hard disk 14 stores a virus pattern file 21 used by the anti-virus program 16 when detecting viruses and a virus scanning history file 22 for storing the virus detection and removal history by the anti-virus program 16.

NAS System Configuration

FIG. 33 is a diagram showing the configuration overview of the NAS system 3 by the fifth embodiment.

As shown in the figure, the NAS system 3 includes a CPU 34, a memory 35, an IP network interface 36 for the connection with the IP network 5, an FC network interface 37 for the connection with the FC network 6, a management network interface 38 for the connection with the management network 7, a hard disk 39, and an internal bus 40 for connecting these components.

The memory 35 stores an NFS/CIFS server program 41 controlling accesses from the management server 1 and the NAS client 2 to the file system provided by the NAS system 3, an NAS management program 43 for controlling the NAS system 3, a snapshot management program 201 managing the snapshots, a remote copy program 501 performing the remote copy of the file systems, and a communication program 44 for the communication by the communication protocols of the IP network 5, the FC network 6, and the management network 7. These programs operate as relevant processing units in collaboration with the CPU 34. For example, the snapshot management program 201 operates as the snapshot management unit 201 in collaboration with the CPU 34.

Furthermore, the memory 35 stores a file system management table 42 for storing the correspondence of the file systems provided by the NAS system 3 with the volumes provided by the storage device 4, and a virus infection file list table 205 for managing and storing the names of the infected files.

The hard disk 39 stores an access log file 45 managing and storing the access history from the NAS client 2 to the file system provided by the NAS system 3, a snapshot history file 202 managing and storing the history of obtaining snapshots, and a remote copy history file 502 managing and storing the remote copy history by the remote copy program 501 to the NAS system 3 at the connected site. Recording the access history to the access log file 45 is performed by the NFS/CIFS server program 41, and recording the snapshot acquisition history to the snapshot history file 202 is performed by the snapshot management program 201. Furthermore, recording the remote copy history to the remote copy history file 502 is performed by the remote copy program 501.

Example of Remote Copy History Files

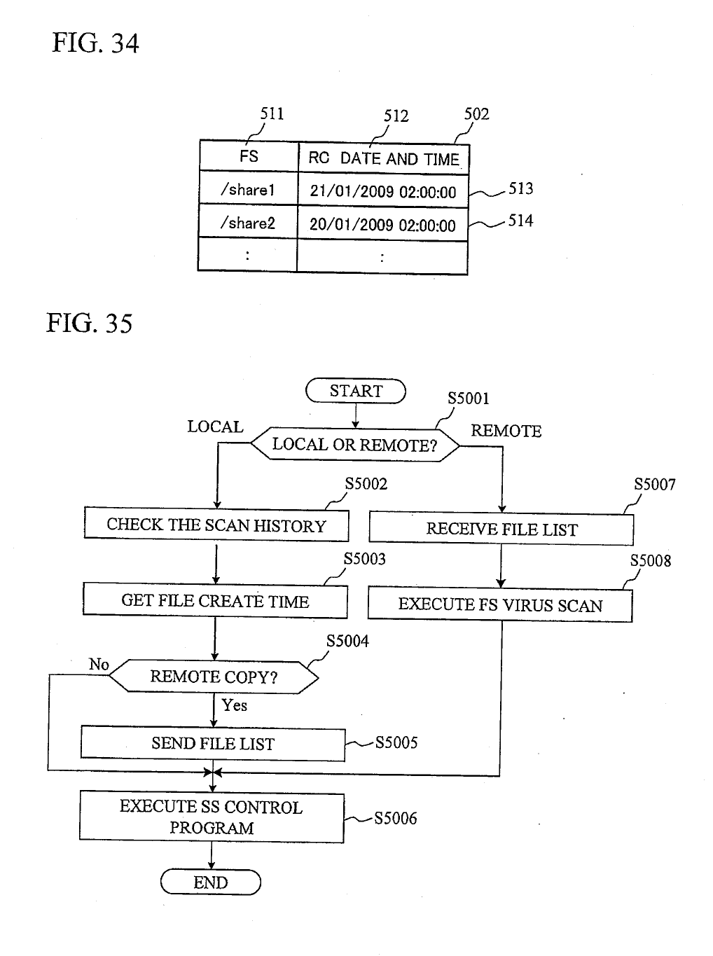

FIG. 34 is a diagram showing an example form of the remote copy history file 502 by the fifth embodiment.

As shown in the figure, the remote copy history file 502 includes the field 511 recording the name of the file system for which a remote copy is performed and the field 512 recording the remote copy date and time of the file system recorded in the field 511.

For example, the entry of the numeral 513 shows that a remote copy was performed for the file system “/share1” at 02:00:00 on Jan. 21, 2009.

The remote copy program 501 of the local site 401 transmits the data stored in the file system provided by the NAS system 3 at the local site 401 to the remote copy program 501 of the remote site 402 with the name of the file system. Meanwhile, the remote copy program 501 of the remote site 402 stores the data stored in the file system received from the remote copy program 501 of the local site 401 to the file system provided by the NAS system 3 at the remote site 402 corresponding with the file system name received from the 401.

Processing Details of Remote Copy Program

FIG. 35 is a flowchart showing the processing details of the remote communication program 504. By the remote communication program 504, operations such as confirming the necessity of performing the virus scanning at the remote site 402, virus scanning at the remote site 402, and others are performed. Note that, at the start of the remote communication program 504, whether to perform it at the local site 401 or the remote site 402 is specified.

FIG. 35 shows that the remote communication program 504 determines whether its own site operates as the local site 401 or as remote site 402 (step S5001). If the result of the determination shows that the program operates at the local site 401, the remote communication program 504 performs the steps S5002 to S5005, then performs S5006, and completes the processing. Meanwhile, if the result of the determination shows that the program operates at the remote site 402, the remote communication program 504 performs the steps S5007 and S5008, then performs S5006, and completes the processing.

Firstly, the processing for the operations at the local site 401 (S5002 to S5006) is described below.

The remote communication program 504 of the local site 401 refers to the virus scanning history file 22, and obtains the names of the infected files and the name of the file system storing the files (step S5002).

Next, the remote communication program 504 accesses the file system provided by the NAS system 3 via the IP network 5, and obtains the creation date and time of the file created at S5002 (step S5003). The file system accessed in this case has the name shown by the field 63 of the virus scanning history file 22.

Furthermore, the remote communication program 504 refers to the remote copy history file 502 and checks if the file system with the name obtained at S5002 created the remote copy at the date and time newer than the creation date and time of the file obtained at S5003 (step S5004). If S5004 determines that the remote copy was not performed, the processing proceeds to S5006. If the remote copy was performed at S5004, the processing proceeds to S5005.

If the result is “Yes” at S5004, the remote communication program 504 transmits the names of all the files and the file system obtained at S5002 to the remote communication program 504 of the remote site 402 via the management network 7 and the WAN 400, and makes the processing proceed to S5006.

Then, the remote communication program 504 boots the snapshot control program 200 at the local site 401, and completes the processing (step S5006).

Next, the processing for the operations at the remote site 402 (S5007, S5008 and S5006) is described below.

The remote communication program 504 of the remote site 402 receives the names of the files and the file system transmitted from the remote communication program 504 of the local site 401 (step S5007).

Next, the remote communication program 504 performs virus scanning using the anti-virus program 16 for the files with the file names received at S5007, stored in the file system with the file system name received at S5007 provided by the NAS system 3 of the remote site 402 (step S5008).

Then, the remote communication program 504 boots the snapshot control program 200 at the remote site 402 and completes the processing (step S5006). Note that the processing details of the snapshot control program 200 are omitted from the description as they are the same as the second embodiment.

In this embodiment, the management servers 1 are installed in the local site 401 and the remote site 402 respectively, and the management server 1 of the remote site 402 performs virus scanning for the NAS system 3 of the remote site 402. However, the management server 1 of the local site 401 may also be permitted to perform virus scanning for the NAS system 3 of the remote site 402.

Summary of Fifth Embodiment

As mentioned above, according to the fifth embodiment of this invention, if an infected file is detected in the file system provided by the NAS system 3 at the local site 401, the management server 1 identifies the snapshot 204 of the newer creation dates and time than the infected file from among the snapshots 204 corresponding with the file system. The attribute of the infected file corresponding with the identified snapshot is changed to “unreadable” or “not executable.”

For the file system created by the remote copy at the remote site 402, virus scanning is performed, and at the same time, the attribute of the infected file of the snapshot 204 is changed to “unreadable” or “not executable.”

This processing has the effect of preventing the recovery executed by the infected files of the snapshot 204 and the invasion of the viruses in the file system from the snapshot. This processing also has the effect of preventing the spreading of the viruses as accesses from the NAS client to the virus infection files in the snapshot 204 can be prevented. Furthermore, the invasion of the viruses when recovering the file system of the remote site 402 and the file system of the local site 401 from the snapshot 204 can be prevented.

### (6) Conclusion

The storage system of this invention removes viruses from the replicated volumes (secondary volumes) of the primary volume corresponding with the file system provided by the NAS system. Therefore, the invasion of viruses when recovering the primary volume from the secondary volumes can be prevented. Furthermore, the file system using the secondary volumes can be provided safely.

Furthermore, as the access control for the infected files of the snapshot of the file system provided by the NAS system is performed, the invasion of the infected files from the snapshot to the file system or the spreading of viruses in the NAS client using the snapshot can also be prevented.

Furthermore, when recovering the file system provided by the NAS system from the external storage devices such as tape devices, the target files of virus scanning can be limited to the presumably infected files. Therefore, the time for virus scanning after the recovery can be reduced, which shortly makes the file system available again.

Note that, though the embodiments of this invention store the anti-virus program 16, the secondary volume selection program, and other programs in the memory 11 of the management server 1, the functions including these and the data storage units (such as the virus scanning history file) installed in the management server 1 and the storage device 4 can also be installed as the functions of the NAS system 3.

Furthermore, this invention can be achieved by the program codes of the software achieving the functions of the embodiments. In this case, the storage medium recording the program codes is provided to the system or the device, and the computer (or the CPU or the MPU) of the system or the device reads the program codes stored in the storage medium. In this case, it can be assumed the program codes read from the storage medium themselves achieve the functions of the above-mentioned embodiments, and the program codes themselves and the storage medium storing them compose this invention. The storage media providing such program codes include, for example, flexible disks, CD-ROMs, DVD-ROMs, hard disks, optical disks, magnetic optical disks, CD-Rs, magnetic tapes, non-volatile memory cards, ROMs, and others.

It may also be permitted that, with reference to the commands by the program codes, the OS (Operating System) and others perform part of or the whole actual processing, and the functions of the above-mentioned embodiments are achieved. Another system may also be permitted in which the program codes read from the storage medium is written to the memory in the computer, and then, with reference to the commands by the program codes, the CPU of the computer or others perform part of or the whole actual processing, and the functions of the above-mentioned embodiments are achieved.

It is also possible that, by distributing the program codes of the software achieving the functions of this invention via the network, they are stored in the system, the storage devices such as hard disks or memories, or the storage medias such as CD-RWs or CD-Rs, and when using them, the computer (or the CPU or the MPU) of the system or the device reads the program codes stored in the relevant storage devices or relevant storage media and execute them.

### REFERENCE SIGNS LIST

1 Management server

2 NAS (Network Attached Storage) client

3 NAS system

4 Storage device

5 IP (Internet Protocol) network

6 FC (Fiber Channel) network

7 Management network

10, 23, 34, 46 CPU (Central Processing Unit)

11, 24, 35, 47 Memory

12, 25, 36 IP network interface

13, 38, 48 Management network interface

14, 26, 39, 52 Hard disk

15, 27, 40, 58 Internal bus

16, 28 Anti-virus program

17 Client communication program

18 Secondary volume selection program

19, 30 NFS/CIFS client program

20, 31, 44, 53 Communication program

21, 32 Virus pattern file

22, 33 Virus scanning history file

29 Server communication program

37, 49 FC network interface

41 NFS/CIFS server program

42 File system management table

43 NAS management program

45 Access log file

50 Primary volume

51a, 51b, 51c Secondary volume (S-VOL)

54 Replication program

55 Volume control program

56 Replication history file

200 Snapshot control program

201 Snapshot management program

202 Snapshot history file

203 Differential volume (D-VOL)

204 Snapshot

205 Virus infection file list table

300 Tape device

301 File selection program

302 Tape device interface

303 Backup history file

304 NDMP (Network Data Management Protocol) server program

305 Backup program

400 WAN (Wide Area Network)

401 Local site

402 Remote site

403 FC/IP gateway

404, 504 Remote communication program

405, 501 Remote copy program

406, 502 Remote copy history file

1. A storage system comprising:
a storage device (4) including at least one primary volume (50);
a backup data storage (51a-51c, 300) for storing a backup data of the primary volume (50);
a file system providing unit (3) connected with the storage device (4) and providing the primary volume as a file system to a client;
a virus detection and removal unit (16) that performs virus scanning for files stored in the file system and detects and removes a virus;
a backup creation date and time storing unit (56, 303) that manages the date and time of creating the backup data (51a-51c, 300) with reference to the primary volume (50); and
a backup data identifying unit (18, 200, 301) that identifies, with reference to information from the backup creation date and time storing unit (56, 303), the backup data whose creation date and time are newer than those of the file in which the virus has been detected,
wherein the virus detection and removal unit (16) performs virus scanning for the identified backup data.

2. The storage system according to claim 1, further comprising a management server (1) and a NAS system (3),
wherein:
the backup data is a secondary volume (51a-51c) created by replicating the primary volume (50),
the management server (1) includes the virus detection and removal unit (16) and the backup data identifying unit (18),
the NAS system includes the file system providing unit (3) and an access history data storing unit (45) that manages an update or delete history of files,
the storage device (4) further includes the backup creation date and time storing unit (56) and the backup data storage (51a-51c),
the backup data identifying unit (18) identifies, with reference to information from the backup creation date and time storing unit (56) and the access history data storing unit (45), the backup data whose creation date and time are newer than those of the file in which the virus has been detected and which has been updated and/or deleted,
the management server (1) further includes an unmount command unit (18) that issues a command to the file system providing unit (3) for suspending providing a file system corresponding with the secondary volume (51a-51c) identified by the backup data identifying unit (18), and
the file system providing unit (3), according to the command from the unmount command unit (18), suspends providing the file system corresponding with the identified secondary volume (51a-51c).

3. The storage system according to claim 1, further comprising a management server (1) and a NAS system (3),
wherein:
the backup data is a snapshot (204) for enabling the access to the primary volume (50),
the management server (1) includes the virus detection and removal unit (16), the backup data identifying unit (200), and a snapshot control unit (200) that manages the snapshot (204),
the NAS system includes the file system providing unit (3), an access history data storing unit (45) that manages an update or delete history of files, and a backup creation date and time storing unit (202),
the storage device (4) further includes a differential volume (203) for storing, if a data stored in the primary volume (50) is updated, a pre-update data of the relevant updated part of the data,
the snapshot (204) is created with reference to a part of data which is not updated in the primary volume (50) and the pre-update data stored in the differential volume (203),
the snapshot control unit (200) issues a command to the file system providing unit (3) for changing the attribute of a file in the primary volume corresponding with the snapshot identified by the backup data identifying unit (200) to “inaccessible,” instead of virus scanning by the virus detection and removal unit (16), and
the file system providing unit (3), according to the command from the snapshot control unit (200), changes the attribute of the file corresponding with the snapshot to “inaccessible.”

4. The storage system according to claim 1, further comprising a management server (1) and a NAS system (3),
wherein:
the backup data is a data stored in an external storage device (300), the management server (1) includes the virus detection and removal unit (16), the backup data identifying unit (301), and the backup creation date and time storing unit (303),
the NAS system includes the file system providing unit (3), an access history data storing unit (45) that manages an update or delete history of files, and a restore processing unit (304) that restores a backup data of the external storage device (300) to the file system provided by the file system providing unit (3),
the backup data identifying unit (301) identifies, with reference to information from the backup creation date and time storing unit (303) and the access history data storing unit (45), the backup data whose creation date and time are newer than those of the file in which the virus has been detected and which has been updated and/or deleted, and
the virus detection and removal unit (16), before the restore processing unit (304) restores the backup data to the file system, performs virus scanning for the identified backup data.

5. The storage system according to claim 1,
wherein:
the backup data is a secondary volume (51a-51c) created by replicating the primary volume (50),
the storage system further comprises an unmount command unit (18) that issues a command to the file system providing unit (3) for suspending providing a file system corresponding with the secondary volume (51a-51c) identified by the backup data identifying unit (18), and
the file system providing unit (3), according to the command from the unmount command unit (18), suspends providing the file system corresponding with the identified secondary volume (51a-51c).

6. The storage system according to claim 1, further comprising an access history data storing unit (45) that manages an update or delete history of files,
wherein:
the backup data identifying unit (18) identifies, with reference to information from the backup creation date and time storing unit (56, 303) and the access history data storing unit (45), the backup data whose creation date and time are newer than those of the file in which the virus has been detected and which has been updated and/or deleted, and
the virus detection and removal unit (16) performs virus scanning for the identified backup data.

7. The storage system according to claim 1,
wherein:
the backup data is a snapshot (204) for enabling the access to the primary volume (50),
the storage system further comprises a snapshot control unit (200) that manages the snapshot (204),
the snapshot control unit (200) issues a command to the file system providing unit (3) for changing the attribute of a file in the primary volume corresponding with the snapshot identified by the backup data identifying unit (18) to “inaccessible,” instead of virus scanning by the virus detection and removal unit (16), and
the file system providing unit (3), according to the command from the snapshot control unit (200), changes the attribute of the file corresponding with the snapshot to “inaccessible.”

8. The storage system according to claim 7,
wherein:
the storage device (4) further includes a differential volume (203) for storing, if a data stored in the primary volume (50) is updated, a pre-update data of the relevant updated part of the data, and
the snapshot (204) is created with reference to a part of data which is not updated in the primary volume (50) and the pre-update data stored in the differential volume (203).

9. The storage system according to claim 1,
wherein:
the backup data is a data stored in an external storage device (300),
the storage system further comprises a restore processing unit (304) that restores a backup data of the external storage device (300) to the file system provided by the file system providing unit (3), and
the virus detection and removal unit (16), before the restore processing unit (304) restores the backup data to the file system, performs virus scanning for the identified backup data.

10. The storage system according to claim 8, further comprising an access history data storing unit (45) that manages an update or delete history of files,
wherein:
the backup data identifying unit (18) identifies, with reference to information from the backup creation date and time storing unit (303) and the access history data storing unit (45), the backup data whose creation date and time are newer than those of the file in which the virus has been detected and which has been updated and/or deleted, and
the virus detection and removal unit (16), before the restore processing unit (304) restores the backup data to the file system, performs virus scanning for the identified backup data.

11. The storage system according to claim 1, further comprising a local site (401) and a remote site (402) connected with the local site (401) via a network (400),
wherein:
each of the local site (401) and the remote site (402) includes the storage device (4), the file system providing unit (3), the virus detection and removal unit (16), the backup creation date and time storing unit (56, 303), and the backup data identifying unit (18),
the primary volume and the backup data of the remote site (402) are data copied from the local site (401),
the virus detection and removal unit (16) of the remote site (402), when the backup data identifying unit (18) of the local site (401) identifies the backup data whose creation date and time are newer than those of the file in which the virus has been detected, performs virus scanning for the copied data of the backup data identified at the local site (401).

12. The storage system according to claim 7, further comprising a local site (401) and a remote site (402) connected with the local site (401) via a network (400),
wherein:
each of the local site (401) and the remote site (402) includes the storage device (4), the file system providing unit (3), the virus detection and removal unit (16), a backup creation date and time storing unit (202), and the backup data identifying unit (18),
the primary volume and the snapshot of the remote site (402) are data created by copying the primary volume of the local site (401),
the snapshot control unit (200) of the remote site (402), when the backup data identifying unit (18) of the local site (401) identifies the snapshot whose creation date and time are newer than those of the file in which the virus has been detected, issues a command to the file system providing unit (3) for changing the attribute of a file in the primary volume corresponding with the snapshot identified by the backup data identifying unit (18) to “inaccessible,” instead of virus scanning by the virus detection and removal unit (16), and
the file system providing unit (3), according to the command from the snapshot control unit (200), changes the attribute of the file corresponding with the snapshot to “inaccessible.”

13. A management method of a file system in a storage system, the storage system including a storage device (4) having at least one primary volume (50), a backup data storage (51a-51c, 300) for storing a backup data of the primary volume (50), a file system providing unit (3) connected with the storage device (4) and providing the primary volume as a file system to a client, a virus detection and removal unit (16) that performs virus scanning for files stored in the file system and detects and removes a virus, a backup creation date and time storing unit (56, 303) that manages the date and time of creating the backup data (51a-51c, 300) with reference to the primary volume (50), and a backup data identifying unit (18) that identifies a backup data to be scanned for viruses, the file system management method comprising the steps of:
causing the backup data identifying unit (18) to identify, with reference to information from the backup creation date and time storing unit (56, 303), the backup data whose creation date and time are newer than those of the file in which the virus has been detected; and
causing the virus detection and removal unit (16) to perform virus scanning for the identified backup data.

14. The file system management method according to claim 13, wherein the backup data is a snapshot (204) for enabling the access to the primary volume (50), and the storage system further includes a snapshot control unit (200) that manages the snapshot (204), the file system management method further comprising the steps of:
causing the snapshot control unit (200) to issue a command to the file system providing unit (3) for changing the attribute of a file in the primary volume corresponding with the snapshot identified by the backup data identifying unit (18) to “inaccessible,” instead of virus scanning by the virus detection and removal unit (16); and
causing the file system providing unit (3) to change, according to the command from the snapshot control unit (200), the attribute of the file corresponding with the snapshot to “inaccessible.”
